(19) United States
(12) Patent Application Publication
(10) Pub. No.: US 2014/0279145 A1
(43) Pub. Date: Sep. 18, 2014

(54) ELICITING ONE MORE MORE BIDS FOR ACCESSING CONTENT AT ONE OR MORE LEVELS OF CONTENT ACCESS FROM TWO OR MORE CLIENT COMPUTING DEVICES

(71) Applicant: Elwha LLC, Bellevue, WA (US)

(72) Inventors: Roderick A. Hyde, Redmond, WA (US); Royce A. Levien, Lexington, MA (US); Richard T. Lord, Tacoma, WA (US); Robert W. Lord, Seattle, WA (US); Mark A. Malamud, Seattle, WA (US); Tony S. Pan, Cambridge, MA (US); Lowell L. Wood, JR., Bellevue, WA (US)

(21) Appl. No.: 13/894,625

(22) Filed: May 15, 2013

Related U.S. Application Data
(63) Continuation of application No. 13/893,879, filed on May 14, 2013.
Application No. 13/893,879 is a continuation-in-part of application No. 13/795,612, filed on Mar. 12, 2013.
Application No. 13/795,612 is a continuation-in-part of application No. 13/854,203, filed on Apr. 1, 2013.
Application No. 13/854,203 is a continuation of application No. 13/853,706, filed on Mar. 29, 2013.
Application No. 13/893,879 is a continuation-in-part of application No. 13/859,061, filed on Apr. 9, 2013.
Application No. 13/859,061 is a continuation of application No. 13/858,656, filed on Apr. 8, 2013.
Application No. 13/893,879 is a continuation-in-part of application No. 13/868,335, filed on Apr. 23, 2013.
Application No. 13/868,335 is a continuation of application No. 13/867,313, filed on Apr. 22, 2013.

(51) Int. Cl. G06Q 30/08

(52) U.S. Cl. CPC G06Q 30/08
USPC 705/26.3

(57) ABSTRACT

Computationally implemented methods and systems include communicating to two or more client computing devices at least one bidding tag that is designed to elicit one or more bids for accessing a content that is being offered for consumption at different levels of access for accessing the content, each of the different levels of access for accessing the content that is being offered for consumption being associated with a different content access latency and associated fee pair, and the at least one bidding tag to be communicated at least partially identifying the content to be offered for consumption, obtaining one or more bids as a result, at least in part, of communicating the at least one bidding tag to the two or more client computing devices, the one or more bids to be obtained being at least one or more requests for accessing the content at one or more levels of the different levels of access for accessing the content that is being offered for consumption; and releasing the content in accordance with the one or more obtained bids. In addition to the foregoing, other aspects are described in the claims, drawings, and text.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

The present application constitutes a continuation-in-part of U.S. patent application Ser. No. 13/795,612, entitled TIERED LATENCY OF ACCESS FOR CONTENT, naming Roderick A. Hyde; Royce A. Levien; Richard T. Lord; Robert W. Lord; Mark A. Malamud; Tony S. Pan; Lowell L. Wood, Jr. as inventors, filed 12, Mar., 2013 with attorney docket no. 0912-003-001-000000, which is currently co-pending or is an application of which a currently co-pending application is entitled to the benefit of the filing date.

The present application constitutes a continuation-in-part of U.S. patent application Ser. No. 13/854,203, entitled PROVIDING ACCESS TO CONTENT IN ACCORDANCE WITH A SELECTED LEVEL OF ACCESS FROM A PLURALITY OF GRADUATED LEVELS OF ACCESS, naming Roderick A. Hyde; Royce A. Levien; Richard T. Lord; Robert W. Lord; Mark A. Malamud; Tony S. Pan; Lowell L. Wood, Jr. as inventors, filed 1, Apr., 2013 with attorney docket no. 0912-003-002-000001, which is currently co-pending or is an application of which a currently co-pending application is entitled to the benefit of the filing date, and which is a continuation of U.S. patent application Ser. No. 13/853,706, entitled PROVIDING ACCESS TO CONTENT IN ACCORDANCE WITH A SELECTED LEVEL OF ACCESS FROM A PLURALITY OF GRADUATED LEVELS OF ACCESS, naming Roderick A. Hyde; Royce A. Levien; Richard T. Lord; Robert W. Lord; Mark A. Malamud; Tony S. Pan; Lowell L. Wood, Jr. as inventors, filed 29, Mar., 2013 with attorney docket no. 0912-003-002-000000.

The present application constitutes a continuation-in-part of U.S. patent application Ser. No. 13/859,061, entitled RECEIVING CONTENT IN ACCORDANCE WITH A PARTICULAR LEVEL OF ACCESS ASSOCIATED WITH A PARTICULAR AMOUNT OF CONTENT ACCESS LATENCY, naming Roderick A. Hyde; Royce A. Levien; Richard T. Lord; Robert W. Lord; Mark A. Malamud; Tony S. Pan; Lowell L. Wood, Jr. as inventors, filed 9, Apr., 2013 with attorney docket no. 0912-003-003-C00001, which is currently co-pending or is an application of which a currently co-pending application is entitled to the benefit of the filing date, and which is a continuation of U.S. patent application Ser. No. 13/858,656, entitled RECEIVING CONTENT IN ACCORDANCE WITH A PARTICULAR LEVEL OF ACCESS ASSOCIATED WITH A PARTICULAR AMOUNT OF CONTENT ACCESS LATENCY, naming Roderick A. Hyde; Royce A. Levien; Richard T. Lord; Robert W. Lord; Mark A. Malamud; Tony S. Pan; Lowell L. Wood, Jr. as inventors, filed 8, Apr., 2013 with attorney docket no. 0912-003-003-000000.

The present application constitutes a continuation-in-part of U.S. patent application Ser. No. 13/868,335, entitled TRANSMITTING CONTENT IN ACCORDANCE WITH A PARTICULAR LEVEL OF REQUESTED ACCESS ASSOCIATED WITH A PARTICULAR AMOUNT OF CONTENT ACCESS LATENCY, naming Roderick A. Hyde; Royce A. Levien; Richard T. Lord; Robert W. Lord; Mark A. Malamud; Tony S. Pan; Lowell L. Wood, Jr. as inventors, filed 23, Apr., 2013 with attorney docket no. 0912-003-008-000000, which is currently co-pending or is an application of which a currently co-pending application is entitled to the benefit of the filing date, and which is a continuation of U.S. patent application Ser. No. 13/867,313, entitled TRANSMITTING CONTENT IN ACCORDANCE WITH A PARTICULAR LEVEL OF REQUESTED ACCESS ASSOCIATED WITH A PARTICULAR AMOUNT OF CONTENT ACCESS LATENCY, naming Roderick A. Hyde; Royce A. Levien; Richard T. Lord; Robert W. Lord; Mark A. Malamud; Tony S. Pan; Lowell L. Wood, Jr. as inventors, filed 22 Apr., 2013 with attorney docket no. 0912-003-004-000000.

### RELATED APPLICATIONS

None

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s). If the listings of applications provided above are inconsistent with the listings provided via an ADS, it is the intent of the Applicant to claim priority to each application that appears in the Priority Applications section of the ADS and to each application that appears in the Priority Applications section of this application. All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

Under the auspices of various alleged “rules” implementing the America Invents Act (AIA), the United States Patent and Trademark Office (USPTO) is purporting to require that an Attorney for a Client make various legal and/or factual statements/commentaries/admissions (e.g. Concerning any “Statement under 37 CFR 1.55 or 1.78 for AIA (First Inventor to File) Transition Application”) related to written description/new matter, and/or advise his Client to make such legal and/or factual statements/commentaries/admissions. Attorney expressly points out that the burden of both alleging that an application contains new matter with respect to its parent(s) and establishing a prima facie case of lack of written description under 35 U.S.C. §112, first paragraph lies firmly on the USPTO. Accordingly, and expressly in view of duties owed his client, Attorney further points out that the AIA legislation, while referencing the first to file, does not appear to constitute enabling legislation that would empower the USPTO to compel an Attorney to either make/advise such legal and/or factual statements/commentaries/admissions. Notwithstanding the foregoing, Attorney/Applicant understand that the USPTO's computer programs/personnel have certain data entry requirements, and hence Attorney/Applicant have provided a designation(s) of a relationship between the present application and its parent application(s) as set forth herein and in any ADS filed in this application, but expressly points out that such designation(s) are not to be construed in any way as any type of commentary and/or admission as to whether or not a claim in the present application is supported by a parent application, or whether or not the present application contains any new matter in addition to the matter of its parent application(s) in general and/or especially as such might relate to an effective filing date before, on, or after 16 Mar. 2013.

Insofar that the Attorney/Applicant may have made certain statements in view of practical data entry requirements of the USPTO should NOT be taken as an admission of any sort. Attorney/Applicant hereby reserves any and all rights to contest/contradict/confirm such statements at a later time. Furthermore, no waiver (legal, factual, or otherwise), implicit or explicit, is hereby intended (e.g., with respect to any statements/admissions made by the Attorney/Applicant in response to the purported requirements of the USPTO related to the relationship between the present application and parent application[s], and/or regarding new matter or alleged new matter relative to the parent application[s]). For example, although not expressly stated and possibly despite a designation of the present application as a continuation-in-part of a parent application, Attorney/Applicant may later assert that the present application or one or more of its claims do not contain any new matter in addition to the matter of its parent application[s], or vice versa.

### SUMMARY

In one or more various aspects, a method includes but is not limited to communicating to two or more client computing devices at least one bidding tag that is designed to elicit one or more bids for accessing a content that is being offered for consumption at different levels of access for accessing the content, each of the different levels of access for accessing the content that is being offered for consumption being associated with a different content access latency and associated fee pair, and the at least one bidding tag to be communicated at least partially identifying the content to be offered for consumption, obtaining one or more bids as a result, at least in part, of communicating the at least one bidding tag to the two or more client computing devices, the one or more bids to be obtained being at least one or more requests for accessing the content at one or more levels of the different levels of access for accessing the content that is being offered for consumption; and releasing the content in accordance with the one or more obtained bids. In some implementations, at least one of the registering, detecting, or displaying being performed by a machine or article of manufacture. In addition to the foregoing, other method aspects are described in the claims, drawings, and text forming a part of the disclosure set forth herein.

In one or more various aspects, one or more related systems may be implemented in machines, compositions of matter, or manufactures of systems, limited to patentable subject matter under 35 U.S.C. 101. The one or more related systems may include, but are not limited to, circuitry and/or programming for effecting the herein-referenced method aspects. The circuitry and/or programming may be virtually any combination of hardware, software, and/or firmware configured to effect the herein-referenced method aspects depending upon the design choices of the system designer, and limited to patentable subject matter under 35 USC 101.

In one or more various aspects, a system includes, but is not limited to, means for communicating to two or more client computing devices at least one bidding tag that is designed to elicit one or more bids for accessing a content that is being offered for consumption at different levels of access for accessing the content, each of the different levels of access for accessing the content that is being offered for consumption being associated with a different content access latency and associated fee pair, and the at least one bidding tag to be communicated at least partially identifying the content to be offered for consumption, means for obtaining one or more bids as a result, at least in part, of communicating the at least one bidding tag to the two or more client computing devices, the one or more bids to be obtained being at least one or more requests for accessing the content at one or more levels of the different levels of access for accessing the content that is being offered for consumption, and means for releasing the content in accordance with the one or more obtained bids. In addition to the foregoing, other system aspects are described in the claims, drawings, and text forming a part of the disclosure set forth herein.

In one or more various aspects, a system includes, but is not limited to, circuitry for communicating to two or more client computing devices at least one bidding tag that is designed to elicit one or more bids for accessing a content that is being offered for consumption at different levels of access for accessing the content, each of the different levels of access for accessing the content that is being offered for consumption being associated with a different content access latency and associated fee pair, and the at least one bidding tag to be communicated at least partially identifying the content to be offered for consumption, circuitry for obtaining one or more bids as a result, at least in part, of communicating the at least one bidding tag to the two or more client computing devices, the one or more bids to be obtained being at least one or more requests for accessing the content at one or more levels of the different levels of access for accessing the content that is being offered for consumption, and circuitry for releasing the content in accordance with the one or more obtained bids. In addition to the foregoing, other system aspects are described in the claims, drawings, and text forming a part of the disclosure set forth herein.

In one or more various aspects, a computer program product, comprising a signal bearing non-transitory storage medium, bearing one or more instructions including, but not limited to, communicating to two or more client computing devices at least one bidding tag that is designed to elicit one or more bids for accessing a content that is being offered for consumption at different levels of access for accessing the content, each of the different levels of access for accessing the content that is being offered for consumption being associated with a different content access latency and associated fee pair, and the at least one bidding tag to be communicated at least partially identifying the content to be offered for consumption, obtaining one or more bids as a result, at least in part, of communicating the at least one bidding tag to the two or more client computing devices, the one or more bids to be obtained being at least one or more requests for accessing the content at one or more levels of the different levels of access for accessing the content that is being offered for consumption, and releasing the content in accordance with the one or more obtained bids. In addition to the foregoing, other computer program product aspects are described in the claims, drawings, and text forming a part of the disclosure set forth herein.

In one or more various aspects, a system includes, but is not limited to a bidding tag transmitting module configured to transmit to two or more client computing devices at least one bidding tag that is designed to elicit one or more bids for accessing a content that is being offered for consumption, at least in part, through the at least one bidding tag at different levels of access for accessing the content, the different levels of access for accessing the content being associated with different amounts of content access latencies and different amounts of associated fees; a bid acquiring module configured to acquire one or more bids from one or more of the two or more client computing devices that the at least bidding tag was transmitted to, the acquiring of the one or more bids being as a result, at least in part, of transmitting the at least one bidding tag, the one or more bids to be obtained being at least one or more requests for accessing the content at one or more levels of the different levels of access for accessing the content that is being offered for consumption through the at least one bidding tag; and a content providing module configured to provide the content in accordance with the one or more acquired bids.

In addition to the foregoing, various other method and/or system and/or program product aspects are set forth and described in the teachings such as text (e.g., claims and/or detailed description) and/or drawings of the present disclosure.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent by reference to the detailed description, the corresponding drawings, and/or in the teachings set forth herein.

### BRIEF DESCRIPTION OF THE FIGURES

For a more complete understanding of embodiments, reference now is made to the following descriptions taken in connection with the accompanying drawings. The use of the same symbols in different drawings typically indicates similar or identical items, unless context dictates otherwise. The illustrative embodiments described in the detailed description, drawings, and claims are not meant to be limiting. Other embodiments may be utilized, and other changes may be made, without departing from the spirit or scope of the subject matter presented here.

FIG. 1 shows a high-level block diagram of a computing system 10* operating in a network environment.

FIGS. 2A, 2B, 2C, 2D, 2E, 2F, 2G and 2H show exemplary selection graphical user interfaces (GUIs) that may be displayed by one or more of the client computing devices 60a, 60b, 60c, and 60d of FIG. 1.

FIGS. 2J, 2K, and 2M show exemplary visual presentations that may be displayed by one or more of the client computing devices 60a, 60b, 60c, and 60d of FIG. 1.

FIG. 3A shows a block diagram of particular implementation of the computing system 10* of FIG. 1.

FIG. 3B shows a block diagram of another implementation of the computing system 10* of FIG. 1

FIG. 4A shows another perspective of the bidding tag transmitting module 102* of FIGS. 3A and 3B (e.g., the bidding tag transmitting module 102′ of FIG. 3A or the bidding tag transmitting module 102″ of FIG. 3B) in accordance with various implementations.

FIG. 4B shows another perspective of the content providing module 106* of FIGS. 3A and 3B (e.g., the content providing module 106′ of FIG. 3A or the content providing module 106″ of FIG. 3B) in accordance with various implementations.

FIG. 5 is a high-level logic flowchart of a process, e.g., operational flow 500, according to some embodiments.

FIG. 6A is a high-level logic flowchart of a process depicting alternate implementations of the bidding tag communicating operation 502 of FIG. 5.

FIG. 6B is a high-level logic flowchart of a process depicting alternate implementations of the bidding tag communicating operation 502 of FIG. 5.

FIG. 6C is a high-level logic flowchart of a process depicting alternate implementations of the bidding tag communicating operation 502 of FIG. 5.

FIG. 6D is a high-level logic flowchart of a process depicting alternate implementations of the bidding tag communicating operation 502 of FIG. 5.

FIG. 6E is a high-level logic flowchart of a process depicting alternate implementations of the bidding tag communicating operation 502 of FIG. 5.

FIG. 6F is a high-level logic flowchart of a process depicting alternate implementations of the bidding tag communicating operation 502 of FIG. 5.

FIG. 6G is a high-level logic flowchart of a process depicting alternate implementations of the bidding tag communicating operation 502 of FIG. 5.

FIG. 6H is a high-level logic flowchart of a process depicting alternate implementations of the bidding tag communicating operation 502 of FIG. 5.

FIG. 6J is a high-level logic flowchart of a process depicting alternate implementations of the bidding tag communicating operation 502 of FIG. 5.

FIG. 6K is a high-level logic flowchart of a process depicting alternate implementations of the bidding tag communicating operation 502 of FIG. 5.

FIG. 7A is a high-level logic flowchart of a process depicting alternate implementations of the bid obtaining operation 504 of FIG. 5.

FIG. 7B is a high-level logic flowchart of a process depicting alternate implementations of the bid obtaining operation 504 of FIG. 5.

FIG. 7C is a high-level logic flowchart of a process depicting alternate implementations of the bid obtaining operation 504 of FIG. 5.

FIG. 8A is a high-level logic flowchart of a process depicting alternate implementations of the content releasing operation 506 of FIG. 5.

FIG. 8B is a high-level logic flowchart of a process depicting alternate implementations of the content releasing operation 506 of FIG. 5.

FIG. 8C is a high-level logic flowchart of a process depicting alternate implementations of the content releasing operation 506 of FIG. 5.

FIG. 8D is a high-level logic flowchart of a process depicting alternate implementations of the content releasing operation 506 of FIG. 5.

FIG. 8E is a high-level logic flowchart of a process depicting alternate implementations of the content releasing operation 506 of FIG. 5.

FIG. 8F is a high-level logic flowchart of a process depicting alternate implementations of the content releasing operation 506 of FIG. 5.

### DETAILED DESCRIPTION

In the following detailed description, reference is made to the accompanying drawings, which form a part hereof. In the drawings, similar symbols typically identify similar or identical components or items, unless context dictates otherwise. The illustrative embodiments described in the detailed description, drawings, and claims are not meant to be limiting. Other embodiments may be utilized, and other changes may be made, without departing from the spirit or scope of the subject matter presented here.

Throughout this application, examples and lists are given, with parentheses, the abbreviation “e.g.,” or both. Unless explicitly otherwise stated, these examples and lists are merely exemplary and are non-exhaustive. In most cases, it would be prohibitive to list every example and every combination. Thus, smaller, illustrative lists and examples are used, with focus on imparting understanding of the claim terms rather than limiting the scope of such terms.

In recent years, the rapid development of computing and networking technologies has fueled explosive growth in demand for content. The word “content” for purposes of this description may be in reference to any one or more of a wide variety of data/information that may be made available through today's computing and/or networking technologies. Some examples of content include news (e.g., business or financial news such as stock or commodities prices, celebrity news, agricultural news, sports news, and so forth), information provided through social media, consumable media such as movies, soundtracks, recordings of sporting events or concerts, and so forth.

As these technologies continue to evolve, actual and potential consumers of such content (hereinafter “content consumers”) are also demanding earlier and more timely access to content. For example, content consumers from the financial or commodity industries are demanding increasingly earlier and earlier access to content (e.g., financial or market data such as stock or commodity prices). That is, early knowledge of certain financial/market/commodity information by, for example, institutional content consumers (e.g., banks, brokerage firms, etc.) may provide huge advantages for those institutional content consumers. Similarly, many everyday consumers of consumable media (e.g., movies, sports program, audio recordings, etc.) have a strong desire to access such consumable media as soon as such media becomes available.

It is also recognized that while some content consumers are willing to pay a large premium for early access to content; other content consumers may not be as willing to pay such a high premium for early access to the same content. It is further recognized that different content consumers will have different needs as to how soon they would like to access content and how much of a premium they would be willing to pay in order to get such content access. Accordingly, computationally-implemented systems and methods are provided herein that allows multiple content consumers to select earlier access to content by paying higher fees, where the earlier the access to content the higher the corresponding or associated fee.

More particularly, the computational-implemented systems and methods to be described herein may be designed to communicate or transmit to a plurality of client computing devices (e.g., two or more computing devices such as workstations, dedicated terminals such as Bloomberg terminals, laptops, mobile computing devices, and so forth) at least one bidding tag that is designed to elicit one or more bids for accessing a content that is being offered for consumption at different levels of access for accessing the content, each of the different levels of access for accessing the content that is being offered for consumption being associated with a different content access latency and associated fee pair, and the at least one bidding tag to be communicated at least partially identifying the content to be offered for consumption. In some cases, the at least one bidding tag that is designed to elicit the one or more bids may elicit the one or more bids by facilitating generation of a selection graphical user interface (selection GUI) at the plurality of client computing devices receiving the at least one bidding tag. The selection GUI generated at a client computing device may be used by a content consumer to select a particular level of access for accessing the content and to submit a bid for accessing the content at the selected level of content access, the selected level of content access being associated with a particular amount of content access latency and a particular amount of associated fee.

The computational-implemented systems and methods may be designed to obtain or acquire one or more bids as a result, at least in part, of communicating the at least one bidding tag to the plurality of client computing devices, the one or more bids to be obtained being at least one or more requests for accessing the content at one or more levels of the different levels of access for accessing the content that is being offered for consumption. The computational-implemented systems and methods may then further be designed to release the content in accordance with the one or more obtained bids. In various implementations, the computational-implemented systems and methods may be implemented at a network computing system such as a network server or at a plurality of network servers as will be described herein.

Turning now to FIG. 1, which illustrates an example environment 100 in which the methods, systems, circuitry, and computer program products in accordance with various embodiments may be implemented at a computing system 10*. In some embodiments, the computing system 10* may be a network device such as a server. In some alternative embodiments, however, the computing system 10* may be a plurality of network devices such as a plurality of network computers, servers, and storage devices. Note that FIGS. 3A and 3B illustrates block diagrams of two alternative implementations of the computing system 10* of FIG. 1. Note further that in the following, “*” represents a wildcard. Thus, references in the following description to, for example, “computing system 10*” may be in reference to the computing system 10′ of FIG. 3A or the computing system 10″ of FIG. 3B (as well as to the computing system 10* of FIG. 1).

In various embodiments, the computing system 10* may electronically communicate with a plurality of client computing devices 60* (e.g., the client computing devices 60a, 60b, 60c, and 60d of FIG. 1) via one or more wireless and/or wired networks 5. Note that for ease of explanation and illustration, only four client computing devices 60a, 60b, 60c, and 60d are illustrated in FIG. 1. Thus, although only four client computing devices 60* are actually depicted in FIG. 1, in alternative implementations, fewer or greater number of client computing devices 60* may be in communication with the computing system 10* of FIG. 1. In various embodiments, each of the client computing devices 60* (client computing device 60a, 60b, 60c, or 60d) illustrated in FIG. 1 may be associated with a corresponding content consumer 62* (e.g., content consumer 62a, 62b, 62c, or 62d). For example, client computing device 60a being associated with at least a content consumer 62a, client computing device 60b being associated with at least a content consumer 62b, and so forth. In some cases, a particular content consumer, such as content consumer 62a, may be associated with a particular client computing device, such as client computing device 60a, when the content consumer 62a has log-in and/or personal access to the computing device 60a. In some cases, a content consumer 62* may be a person or persons while in other cases; a content consumer may be an organization such as a business entity. In various embodiments, a client computing device 60* may be a general purpose computing device such as a desktop computer, a workstation, a laptop computer, a tablet computer, a Smartphone, a PDA (personal digital assistant, and so forth). Alternatively, a client computing device 60* may be a dedicated or specialized system such as an electronic trading platform (e.g., Bloomberg terminal). In various embodiments, each of the client computing devices 60* may also be able to communicate with the other client computing devices 60*.

The one or more wireless and/or wired networks 5 illustrated in FIG. 1 may include, for example, a local area network (LAN), a wireless local area network (WLAN), a personal area network (PAN), Worldwide Interoperability for Microwave Access (WiMAX), public switched telephone network (PTSN), general packet radio service (GPRS), cellular networks including cellular data networks, and/or other types of communication networks.

In various embodiments, the computing system 10* may be designed to offer to a plurality of content consumers 62* (via client computing devices 60*) an opportunity to select particular levels of content access from multiple levels of content access (associated with different amounts of content access latencies/fees) for accessing a particular content 20. For example, the computing system 10* may be designed to offer different levels of access (associated with different content access latencies) to a particular content 20 (e.g., a consumable media such as a feature length movie or financial or market news) by at least initially communicating (e.g., transmitting) at least one bidding tag 30 to, for example, a plurality of client computing devices 60*. The at least one bidding tag 30 that may be communicated by the computing system 10* may at least partially identify the content 20 to be offered for consumption and in some cases, may identify the various levels of content access (e.g., various levels of content access latencies and associated fees) that are available for selecting/electing by one or more content consumers 62*. In various embodiments, the at least one bidding tag 30 that may be communicated by the computing system 10* may be designed to elicit one or more bids 40 (e.g., one or more requests for accessing the content 20 at one or more levels of content access associated with one or more levels of content access latencies/fees) from one or more content consumers 62* through their devices (e.g., client computing devices 60*).

For example, in order to elicit the one or more bids 40 from one or more content consumers 62*, the at least one bidding tag 30 that may be communicated may comprise of data 32 that may facilitate generation, at the one or more client computing devices 60* that receives the data 32 of a selection graphical user interface (selection GUI) that may be used by one or more content consumers 62* to submit one or more bids 40 for accessing the content 20 at one or more levels of content access from multiple and incremental levels of content access that are available, where each incremental level of content access that is available for selecting by a content consumer 62* being associated with a different content access latency and associated fee pair (e.g., each level of content access latency that may be available for selection by a content consumer 62* may be associated with a corresponding and associated fee).

In some cases, the at least one bidding tag 30 that may be communicated by the computing system 10* may provide generic information related to a particular content 20 that is to be offered for consumption. For example, in some instances, a bidding tag 30 may contain just enough information about a particular content 20 to make the particular content 20 being offered for consumption identifiable (e.g., identifiable as a particular type of news or a particular movie) without providing or disclosing the core component or components of the content 20 (e.g., core component of the content 20 that if revealed would render the content 20 essentially worthless). For example, if the particular content 20 to be offered for consumption is a movie, then the bidding tag 30 that is designed to elicit bids for such content 20 may include at least the title of the movie, and in some cases, additional data such as names of the cast and/or crew, movie trailer or trailers, and so forth.

If the particular content 20 to be offered for consumption is, on the other hand, financial or market news, then the bidding tag 30 that is communicated to the client computing devices 60* to elicit bids 40 for such a content 20 may merely identify the type of financial/market news (e.g., “Share price of ACME Corp. stocks on May 26, 2016) that is included in the content 20 without providing essential information (e.g., without providing the actual share price) related to the financial/market news. In yet another example, if the particular content 20 to be offered access to is news related to a particular celebrity, than the bidding tag 30 that is communicated to the client computing devices 60* to elicit bids 40 for such a content 20 may indicate that the content 20 is “celebrity news” or may indicate the name of the celebrity without indicating what the news related to the celebrity is all about (e.g., the bidding tag 30 may indicate that the content 20 is news about “Lindsey Lohan” without identifying the specific news related to Lindsey Lohan). Thus, in various implementations, a bidding tag 30 may provide certain generic information related to a particular content 20 being offered for consumption without providing core or essential data related to the particular content 20.

In various embodiments, in response at least in part to receiving a bidding tag 30 from the computing system 10*, a client computing device 60 may visually present (e.g., display) a selection GUI (FIGS. 2A, 2B, 2C, 2D, 2E, 2F, 2G, and 2H illustrate some exemplary selection GUIs) for selecting a particular level of access for accessing a particular content 20 from a plurality of graduated levels of access for accessing the content 20, the plurality of graduated levels of access for accessing the particular content 20 being for accessing the particular content 20 with varying amounts of content access latencies and for varying amounts of associated fees. In other words, a client computing device 60* may be designed to present a particular type of GUI (which will be referred to herein as a “selection GUI”) in response, at least in part, to receiving a bidding tag 30 from the computing system 10*, the presented selection GUI allowing a user (e.g., content consumer 62*) to select a particular level of access for accessing a particular content 20, the particular level of access that may be selected being associated with a particular amount of latency for accessing the content 20 and for a particular amount of associated fee. As will be further described herein, a bidding tag 30 that may be received by a client computing device 60* may include certain information/data that may be needed in order to generate a selection GUI at the client computing device 60*. Note that FIGS. 2A, 2B, 2C, 2D, 2E, 2F, 2G, and 2H illustrate some exemplary selection GUIs that the client computing devices 60* may display as will be discussed in greater detail herein.

Note that the word “latency,” as will be used herein, may be in reference to a time delay for accessing content. For example, in some embodiments, the word “latency,” as will be used herein, may be in reference to an increment or interval of time between some arbitrary point in time, such as the earliest point in time that a particular content 20 is available for consumption, and the point in time that the particular content 20 is actually made available or accessible. For example, in the case where the particular content 20 that is being offered for consumption includes a feature length movie, the related latency for accessing such a content 20 may be the amount of time between when the movie is initially released in theaters and the point in time that the movie is actually made available through, for example, the exemplary environment 100 of FIG. 1.

In the case where the particular content 20 relates to a price of a particular stock, the related latency may be the amount of time between when the price is first available through, for example, Dow Jones or Nasdaq and when the price is actually made accessible or released through, for example, the exemplary environment 100 of FIG. 1. In various implementations, the point in time in which the “latency clock” begins may not be relevant since the point in time that the latency clock begins can be completely arbitrary (e.g., could begin when a movie is initially released in theaters or at some arbitrary point in time afterwards). That is, the phrase “latency,” as used herein, simply relates to a time increment or interval. Thus, a more relevant aspect in accordance with these implementations may be the relevant amounts of latencies/fees associated with different levels of content access (e.g., smaller latencies and higher fees are typically associated with greater content access).

In response to the presentation of a selection GUI (e.g., the selection GUI 200a or 200b of FIG. 2A or 2B) by a client computing device 60*, a content consumer 62* (e.g., an end user) using the client computing device 60* may select a particular level of content access to access content 20 that is associated with a particular amount of content access latency and a particular amount of associated fee. In some implementations, in response to receiving an input (e.g., election of a particular level of content access with a particular level of latency/fee) from the content consumer 62*, the client computing device 60* may transmit to the computing system 10* at least one bid 40 (e.g., a request for accessing the content 20 at a particular level of access for accessing the content 20 that is associated with a particular amount of fee/content access latency) via the one or more wireless and/or wired networks 5.

In various embodiments, in response to receiving one or more bids 40 from one or more client computing devices 60*, the computing system 10* may release (e.g., provide access) to the one or more client computing device 60* the content 20 that was requested through the one or more received bids 40. The content 20 that may be released by the computing system 10* may be released to the one or more client computing devices 60* in accordance with one or more received bids 40. In some embodiments, this may mean that the content 20 may be released to various client computing devices 60* at different points in time.

For example, suppose the various content consumers 62* illustrated in FIG. 1 using their client computing devices 60* had requested various levels of content access (e.g. the content consumer 62a of FIG. 1 using client computing device 60a submitting a bid 40 to the computing system 10* that requested highest level of content access associated with lowest content access latency and highest fee, the content consumer 62b using client computing device 60b submitting to the computing system 10* a bid 40 that requested 2^{nd} highest level of content access associated with 2^{nd} lowest content access latency and 2^{nd} highest fee, and content consumers 62c and 62d using their client computing devices 60c and 60d submitted bids 40 that requested the lowest level of content access associated with 3^{rd} lowest content access latency and 3^{rd} highest fee), then the content 20 may be released to the different client computing devices 60* at three different points in time. For instance, the computing system 10* may first release the content 20 to client computing device 60a (since the content consumer 62a had requested highest level of content access). The computing system 10* may next release the content 20 to client computing device 60b (since the content consumer 62b had requested the 2^{nd} highest level of content access). Finally, the computing device 10* may release the content 20 to the client computing devices 60c and 60d last (since the content consumers 62c and 62d had requested the lowest level of content access). Thus, in this example, the content 20 is released to the different client computing devices 60* only after the different latencies that were requested through the received bids 40 had expired.

In alternative embodiments, however, the content 20 may be released (e.g., transmitted) to the various client computing device 60* prior to the requested latencies (as requested through bids 40) lapsing. For these embodiments, the various client computing device 60* may be instructed, for example, by the computing system 10* to withhold the received content 20, at least temporarily, and not provide (e.g., visually display or audibly present) the received content 20 until the requested latency (as requested through a bid 40) has lapsed.

In some implementations, the computing system 10*, in addition to being able to release a particular content 20 to a plurality of client computing devices 60*, may also be designed to release (e.g., provide) previous viewer information 22 and/or contextual data 24 to at least a subset of the plurality of client computing devices 60*. The previous viewer information 22 that may be released by the computing system 10* may provide various information related to users (e.g., content consumers 62*) who may have previously accessed a particular content 20. For example, if a particular content consumer 62*, such as client consumer 62c of FIG. 1, elects to receive a specific content 20 (e.g., a content 20 that is related to the price of a particular stock on a particular date) one second (e.g., one second latency) following the initial release of the specific content 20, then the computing system 10* may provide to the client computing device 60c (associated with content consumer 62c) previous viewer information 22 that indicates, for example, how many other content consumers (e.g., content consumers 62a and 62b of FIG. 1) have already previously accessed the content 20 (e.g., those content consumers 62* who accessed the content 20 within the one second following the initial release of the specific content 20), the identities of those other content consumers 62a and 62b who have already accessed the content 20, and/or how those other content consumers 62a and 62b may have previously viewed the content 20 (e.g., the communication channels such as bandwidth of the communication channels that were used by the other content consumers in order to access the content 20). In some cases, such information may prove valuable to the content consumer 62c (e.g., an institutional user such as a brokerage firm) receiving the content 20 when, for example, the content consumer 62c is making business/financial decisions.

In some implementations, the previous viewer information 22 that may be released by the computing system 10* may be released at the same time or proximate to the point in time in which a bidding tag 30 is released by the computing system 10*. By providing such information to a content consumer 62*, the content consumer 62* may make a more informed decision as to whether to purchase the corresponding content 20 for a particular fee with a particular amount of latency. In other implementations, the previous viewer information 22 may be released by the computing system 10* to one or more client computing devices 60* at the same time or proximate to the point in time in which the content 20 is released to the one or more client computing devices 60*.

As indicated above, in some implementations, the computing system 10* may be additionally or alternatively designed to release to one or more client computing devices 60* contextual data 24 related to a particular content 20 that is being released to the one or more client computing devices 60*. In various embodiments, contextual data 24 is data that provides information related to a particular content 20 and that may supplement the particular content 20 being released. For example, if the particular content 20 that is to be released by the computing system 10* is financial/market news (e.g., price of a particular stock or commodity on a particular date) then the computing system 10* may be further designed to release a corresponding contextual data 24 that provides historical financial/market data (e.g., historical prices of the particular stock or commodity). On the other hand, if the particular content 20 that is to be released by the computing system 10* is a consumable media such as a feature length movie, then the contextual data 24 that may be released by the computing system 10* may be one or more movie trailers that may be trailers for the movie or for another movie (e.g., another movie in the same genre). In some cases, such contextual data 24 may only be provided to those content consumers 62* who have paid a higher premium for accessing the associated content 20 (e.g., content consumers 20 who have higher level of access to the content 20). In other cases, however, a content consumer 62* may actually pay a higher premium in order to avoid being provided with such contextual data 24. For example, if the content 20 being offered for consumption is a movie, than some content consumers 20 may not wish to see movie trailers of other movies since such trailers are essentially advertisements. A more detailed discussion related to various aspects of the exemplary environment of FIG. 1 will be provided with respect to the processes and operations to be described herein.

Referring now to FIGS. 2A, 2B, 2C, 2D, 2E, 2F, 2G, and 2H, which illustrate exemplary selection GUIs 200a, 200b, 200c, 200d, 200e, 200f, 200g, and 200h that may be displayed by, for example, one or more of the client computing devices 60* of FIG. 1 in response, at least in part, to receiving at least one bidding tag 30 from the computing system 10*. In various embodiments, the exemplary selection GUIs illustrated in FIGS. 2A, 2B, 2C, 2D, 2E, 2F, 2G, and 2H may be used by, for example, a content consumer 62* in order to select a level of access for accessing content 20 from a plurality of graduated levels of access for accessing the content 20, the selected level of access for accessing the content 20 being at least associated with a particular amount of content access latency/corresponding fee, and each of the plurality of graduated levels of access for accessing the content 20 that the selected level of access was selected from being associated with a different content access latency/associated fee pair.

Turning particularly now to FIG. 2A, which illustrates a selection GUI 200a that may be generated by a client computing device 60* in response, at least in part, to the client computing device 60* receiving at least one bidding tag 30. As illustrated, the selection GUI 200a may include a slider feature 201a for selecting a particular level of access for accessing a particular content 20 from a plurality of graduated levels of access for accessing the content 20 that are each associated with a different content access latency/associated fee pair, where higher levels of content access being associated with increasingly higher fees and increasingly lower content access latencies. The slider feature 201a includes a slider icon 202a that may be designed to be moveable along an elongated element 204a. The slider icon 202a may be moved along the elongated element 204a by a content consumer 62* (e.g., an end user) by a variety of different means. For example, if the slider feature 201a is being displayed through a touchscreen then a content consumer 62* may simply move the slider icon 202a by touching the slider icon 202a on the touchscreen with a finger and moving the slider icon 202a by sliding or “pushing” the slider icon 202a along the elongated element 204a being displayed on the touchscreen. Alternatively, a cursor that is being controlled by a mouse (which may be further under the control of a content consumer 62*) may be used in order to move the slider icon 202a along the elongated element 204a.

The elongated element 204a having a first end 208a and a second end 210a, and the entire length of the elongated element 204a being divided into graduated levels of access for accessing a particular content 20 (e.g., Share price for ACME), the multiple graduated levels of access being represented at multiple points 212a along the elongated element 204a, and each level of access being associated with a different content access latency and associated fee pair (e.g., each point along the elongated element 204a is associated with a different level of content access being further associated with a different amount of content access latency and a different amount of associated fee). Thus, in order for a content consumer 62* to select a particular level of content access (with a particular amount of latency and a particular amount of associated fee), the content consumer 62* slides the slider icon 202a until it is located at the desired position (which corresponds to a particular level of content access that is further associated with a particular amount of content access latency and a particular amount of associated fee) along the elongated element 204a and then enters the access level selection by, for example, tapping or clicking the slider icon 202a or the “enter” icon 205a, or by other means for inputting the selection.

As further illustrated in FIG. 2A, the selection GUI 200a may further include a content identifier 206a, an icon 207a for displaying a previous viewer information (e.g., information related to one or more content consumers 62* who have previously accessed the content 20 including the number of one or more content consumers 62* who have already accessed the content 20, the identities of those one or more content consumers 62*, and so forth), and icon 209a for displaying contextual information related to the content 20, which in this case is historical market data related to the content 20 (e.g., a price of a particular stock on a particular day) being offered for access. In various embodiments, icon 207a and/or icon 209a may be selected or activated by a content consumer 62* by “tapping” or “clicking” these icons.

Note that in various embodiments a client computing device 60* may generate the selection GUI 200a of FIG. 2A (as well as the selection GUI 200b, 200c, 200d, 200e, 200f, 200g, or 200h of FIG. 2B, 2C, 2D, 2E, 2F, 2G, or 2H) based, at least in part, on data/information provided through at least one bidding tag 30 that may have been communicated/transmitted by the computing system 10* of FIG. 1. For these embodiments, the information that may be provided by a bidding tag 30 may include, for example, the name or type of content 20 being offered for access, the various levels of latencies/fees available for selection, and so forth. In any event, such information may be used in order to construct/generate a selection GUI (e.g., selection GUI 200a, 200b, 200c, 200d, 200e, 200f, 200g, or 200h of FIG. 2A, 2B, 2C, 2D, 2E, 2F, 2G, or 2H) that may be displayed by a client computing device 60*.

Referring now to FIG. 2B, which shows another exemplary selection GUI 200b that may be presented by one or more of the client computing devices 60* of FIG. 1 in response, at least in part, to receiving at least one bidding tag 30 from the computing system 10*. As illustrated, the selection GUI 200b includes a plurality of icons 220b that may be clicked or tapped (e.g., tapped on a touch screen) in order to select a particular level of content access from a plurality of graduated levels of content access. As depicted, each of the illustrated icons (which are each associated with a different level of content access) may be associated with a different amount of latency (e.g., from zero weeks for the far left icon to 10 weeks to the far right icon). Each of the illustrated icons 220b being further associated with a different amount of associated fee (e.g., from $100 for the far left icon to $5 for the far right icon). Thus, each of the icons 220b being associated with a different level of content access and a different content access latency/associated fee pair. As further illustrated in FIG. 2B, the selection GUI 200b may further include a content identifier 206b, which identifies the content 20 that is being offered for consumption as being a feature movie with the title “Star Battle.” The selection GUI 200b is further illustrated as having an icon 207b for displaying/retrieving a movie trailer.

Referring to FIG. 2C, which illustrates another exemplary selection GUI 200c that may be presented by one or more of the client computing devices 60* of FIG. 1 in response, at least in part, to receiving at least one bidding tag 30 from the computing system 10*. The selection GUI 200c, similar to the selection GUI 200a of FIG. 2A, includes a slider feature 201c that further includes a slider icon 202c and an elongated element 204c, the slider icon 202c being moveable along the elongated element 204c based on user input (e.g., a user or content consumer 62* moving the slider icon 202c by sliding his/her finger along a touch screen or using a cursor to move the slider icon 202c). The different points along the entire length of the elongated element 204c being associated with different levels of access 212c to content 20, where each of these points along the elongated element 204c being associated with a different amount of latency (e.g., 1 minute, 1 second, 2 microseconds, etc.) and a different amount of fee (e.g., no fee, $10,000, $50,000, etc.). The selection GUI 200c, as further illustrated, includes a content identifier 206c and textual information 209c (which indicates information related to users who had previously accessed the content). Note that in alternative implementations, the textual information 209c may be replaced with an option (e.g., an option in the form of an icon) to display such textual information. In some cases, an end user (e.g., a content consumer 62*) may use the selection GUI 200c to select a particular level of content access by moving the slider icon 202c to the appropriate location (e.g., a location that is associated with the desired level of content access for a particular level of latency/fee) along the elongated element 204c and clicking or tapping icon 205c or the slider icon 202c.

FIG. 2D illustrates yet another selection GUI 200d that comprises a slider feature 201d and that may be presented by one or more of the client computing devices 60* of FIG. 1 in response, at least in part, to receiving at least one bidding tag 30 from the computing system 10*. The slider feature 201d includes a slider icon 202d that is moveable along an elongated element 204d. The illustrated selection GUI 200d may be used by an end user (e.g., a content consumer 62*) for selecting an access level for accessing a consumable media, which in this case is a movie. The selection GUI 200d, as depicted, also includes a content identifier 206d and an icon 207d for retrieving/displaying a movie trailer associated with the movie. In some cases, an end user (e.g., a content consumer 62*) may use the selection GUI 200d to select a particular level of content access by moving the slider icon 202d to the appropriate location (e.g., a location that is associated with the desired level of content access for a particular level of latency/fee) along the elongated element 204d and clicking or tapping icon 205d or the slider icon 202d.

FIG. 2E illustrates yet another selection GUI 200e that comprises a slider feature 201e and that may be presented by one or more of the client computing devices 60* of FIG. 1 in response, at least in part, to receiving at least one bidding tag 30 from the computing system 10*. The slider feature 201e includes a slider icon 202e that is moveable along an elongated element 204e. The illustrated selection GUI 200e may be used by an end user (e.g., a content consumer 62*) for selecting an access level for accessing news, which in this case is celebrity news. The selection GUI 200e, as depicted, also includes a content identifier 206e. In some cases, an end user (e.g., a content consumer 62*) may use the selection GUI 200e to select a particular level of content access by moving the slider icon 202e to the appropriate location (e.g., a location that is associated with the desired level of content access for a particular level of latency/fee) along the elongated element 204e and clicking or tapping icon 205e or the slider icon 202e.

FIG. 2F illustrates yet another selection GUI 200f that comprises a slider feature 201f and that may be presented by one or more of the client computing devices 60* of FIG. 1 in response, at least in part, to receiving at least one bidding tag 30 from the computing system 10*. The slider feature 201f includes a slider icon 202f that is moveable along an elongated element 204f. The illustrated selection GUI 200f may be used by an end user (e.g., a content consumer 62*) for selecting an access level for accessing news, which in this case is celebrity news related specifically to Lindsey Lohan. The selection GUI 200f, as depicted, also includes a content identifier 206f, which identifies the content 20 as Lindsey Lohan news, does not identify the type of news (e.g., what type of news related to Lindsey Lohan) that is included in the content 20. In some cases, an end user (e.g., a content consumer 62*) may use the selection GUI 200f to select a particular level of content access by moving the slider icon 202f to the appropriate location (e.g., a location that is associated with the desired level of content access for a particular level of latency/fee) along the elongated element 204f and clicking or tapping icon 205f or the slider icon 202f.

FIG. 2G illustrates yet another selection GUI 200g that comprises a slider feature 201g and that may be presented by one or more of the client computing devices 60* of FIG. 1 in response, at least in part, to receiving at least one bidding tag 30 from the computing system 10*. The slider feature 201g includes a slider icon 202g that is moveable along an elongated element 204g. Different points along the elongated element 204g being associated with different levels of access 212g to the content 20. The illustrated selection GUI 200g may be used by an end user (e.g., a content consumer 62*) for selecting an access level for accessing agricultural news, which in this case is a crop report. The selection GUI 200g, as depicted, also includes a content identifier 206g and previous user information 207g, which indicates information related to users who have previously accessed the content 20. In some cases, an end user (e.g., a content consumer 62*) may use the selection GUI 200g to select a particular level of content access by moving the slider icon 202g to the appropriate location (e.g., a location that is associated with the desired level of content access for a particular level of latency/fee) along the elongated element 204g and clicking or tapping icon 205g or the slider icon 202g.

FIG. 2H illustrates yet another selection GUI 200h that comprises a slider feature 201h and that may be presented by one or more of the client computing devices 60* of FIG. 1 in response, at least in part, to receiving at least one bidding tag 30 from the computing system 10*. The slider feature 201h includes a slider icon 202h that is moveable along an elongated element 204h. The illustrated selection GUI 200h may be used by an end user (e.g., a content consumer 62*) for selecting an access level for accessing Federal Reserve news (e.g., news related interest rates). The selection GUI 200h, as depicted, also includes a content identifier 206h. In some cases, an end user (e.g., a content consumer 62*) may use the selection GUI 200h to select a particular level of content access by moving the slider icon 202h to the appropriate location (e.g., a location that is associated with the desired level of content access for a particular level of latency/fee) along the elongated element 204h and clicking or tapping icon 205h or the slider icon 202h.

Turning now to FIGS. 2J, 2K, and 2M, which illustrate various exemplary visual presentations 250* that are either presenting a particular content 20 (e.g., the visual presentation 250j of FIG. 2J) or that may be used for accessing/presenting content 20 (e.g., the visual presentations 250k and 250m of FIGS. 2K and 2M). In some embodiments, the example visual presentations 250* illustrated in FIGS. 2J, 2K, and 2M may be displayed by a client computing device 60* after a particular amount of latency has lapsed (e.g., the amount of latency, which in some cases may be zero, that was selected by, for example, a content consumer 62* using, for example, one of the selection GUI 200* illustrated in FIG. 2A, 2B, 2C, 2D, 2E, 2F, 2G, or 2H). Referring particularly now to FIG. 2J, which shows a visual presentation 250j that displays content 252 in the form of stock market news. As depicted, the visual presentation 250j also includes previous user information 254 that provides information of one or more users (e.g., content consumers 62*) who have previously accessed the content 20. As further illustrated in FIG. 2J, the visual presentation 250j may also include contextual data 256 in the form of historical market data (e.g., historical stock prices).

FIG. 2K illustrates a visual presentation 250k for accessing content 20, which in this case is a feature length movie (with the title of “The Godmother”). As shown, the visual presentation 250k may include a content identifier 206k and an icon 220k for retrieving and/or playing the movie. In order to retrieve and/or play the movie, the user may tap or click the icon 220k. Note that in some cases, the visual presentation 250k may be displayed by a client computing device 60* even before the agreed upon content access latency has elapsed (e.g., the content access latency that was requested through a selection GUI 200*). In such situations, the functional aspects of the visual presentation 250k that is displayed may be disabled at least until the content access latency has actually lapsed. That is, icon 220k (for retrieving the content 20) may be disabled at least until the agreed upon content access latency has lapsed.

FIG. 2M illustrates a visual presentation 250m for accessing content 20, which in this case is celebrity news. As shown, the visual presentation 250m may include a content identifier 206m and a link 221m (e.g., a hyperlink) for retrieving and/or displaying the celebrity news. In order to retrieve and/or play the movie, the user may tap or click the link 221m. Note that similar to the previous example, the visual presentation 250m may be displayed by a client computing device 60* even before the agreed upon content access latency has elapsed (e.g., the content access latency that was requested through a selection GUI 200*). In such situations, the functional aspects of the visual presentation 250m that is displayed may be disabled at least until the content access latency has actually lapsed. That is, the link 221m of the visual presentation 250m may be disabled at least until the agreed upon content access latency has lapsed.

Referring now to FIGS. 3A and 3B, illustrating two block diagrams representing two different implementations of the computing system 10* of FIG. 1 and that are designed to execute the operations and processes to be described herein. In particular, and as will be further described herein, FIG. 3A illustrates a computing system 10′ that is the “hardwired” or “hard” implementation of a system that can implement the operations and processes to be described herein. The computing system 10′ may comprise certain logic modules including, for example, a bidding tag transmitting module 102′, a bid acquiring module 104′, and/or a content providing module 106′ that are implemented using purely hardware or circuitry components (e.g., application specific integrated circuit or “ASIC”). In contrast, FIG. 3B illustrates a computing system 10″ that is the “soft” implementation of a system that can implement the operations and processes to be described herein. In various embodiments, the computing system 10″ may also include certain logic modules including, for example, a bidding tag transmitting module 102″, a bid acquiring module 104″, and/or a content providing module 106″ that are implemented using electronic circuitry (e.g., one or more processors 116 including one or more microprocessors, controllers, etc.) executing one or more programming instructions (e.g., software in the form of computer readable instructions 152—see FIG. 3B).

The embodiments of the computing system 10* illustrated in FIGS. 3A and 3B are two extreme implementations of a system in which all of the logic modules (e.g., the bidding tag transmitting module 102′, the bid acquiring module 104′, and the content providing module 106′) are implemented using purely hardware solutions (e.g., circuitry such as ASIC) as illustrated in FIG. 3A or in which all of the logic modules (e.g., the bidding tag transmitting module 102″, the bid acquiring module 104″, and the content providing module 106″) are implemented using software solutions (e.g., programmable instructions in the form of computer readable instructions 152 being executed by hardware such as one or more processors 116) as illustrated in FIG. 3B. Since there are many ways of combining hardware, software, and/or firmware in order to implement the various logic modules (e.g., the bidding tag transmitting module 102*, the bid acquiring module 104*, and the content providing module 106*), only the two extreme implementations (e.g., the purely hardware solution as illustrated in FIG. 3A and the software solution of FIG. 3B) are illustrated here. It should be noted here that with respect to the “soft” implementation illustrated in FIG. 3B, hardware in the form of circuitry such as one or more processors 116 are still needed in order to execute the software. Further details related to the two implementations of the computing system 10* illustrated in FIGS. 3A and 3B will be provided in greater detail below.

In some instances, one or more components may be referred to herein as “configured to,” “configured by,” “configurable to,” “operable/operative to,” “adapted/adaptable,” “able to,” “conformable/conformed to,” “designed to,” etc. Those skilled in the art will recognize that such terms (e.g., “configured to”) generally encompass active-state components and/or inactive-state components and/or standby-state components, unless context requires otherwise.

Referring particularly now to FIG. 3A, which illustrates a block diagram of an computing system 10′ that includes a bidding tag transmitting module 102′, a bid acquiring module 104′, a content providing module 106′, a memory 114, one or more processors 116 (e.g., one or more microprocessors), and/or a network interface 112 (e.g., one or more network interface cards or “NICs”). In various embodiments, the memory 114 may store content 20 (e.g., news content or consumable media such as a feature length movie, a recording of a sports event, or a recording of a concert).

In various embodiments, the bidding tag transmitting module 102′ of FIG. 3A is a logic module that may be designed to, among other things, transmit (e.g., communicate) to two or more client computing devices 60* at least one bidding tag 30 that is designed to elicit one or more bids 40 for accessing a content 20 that is being offered for consumption, at least in part, through the bidding tag 30 at different levels of access for accessing the content 20, the different levels of access for accessing the content 20 being associated with different amounts of content access latencies and different amounts of associated fees. In contrast, the bid acquiring module 104′ of FIG. 3A is a logic module that may be configured to acquire (e.g., obtain) one or more bids 40 from one or more of the two or more client computing devices 60* that the at least bidding tag 30 was transmitted to, the acquiring of the one or more bids 40 being as a result, at least in part, to transmitting of the at least one bidding tag 30, the one or more bids 40 to be obtained being at least one or more requests for accessing the content 20 at one or more levels of the different levels of access for accessing the content 20 that is being offered for consumption through the at least one bidding tag 30. The content providing module 106′ of FIG. 3A, on the other hand, is a logic module that may be configured to provide (e.g. release) access to the content 20 in accordance with the one or more obtained bids 40.

Turning now to FIG. 3B, which illustrates a block diagram of another computing system 10″ that can implement the operations and processes to be described herein. As indicated earlier, the computing system 10″ in FIG. 3B is merely the “soft” version of the computing system 10′ of FIG. 3A because the various logic modules: the bidding tag transmitting module 102″, the bid acquiring module 104″, and the content providing module 106″ are implemented using one or more processors 116 (e.g., one or more microprocessors or controllers) executing software (e.g., computer readable instructions 152) rather than being implemented using purely hardware (e.g., ASIC) solutions as was the case in the computing system 10′ of FIG. 3A. Thus, the bidding tag transmitting module 102″, the bid acquiring module 104″, and the content providing module 106″ of FIG. 3B may be designed to execute the same functions as the bidding tag transmitting module 102′, the bid acquiring module 104′, and the content providing module 106′ of FIG. 3A. The computing system 10″, as illustrated in FIG. 3B, may include other components (e.g., the network interface 112, and so forth) that are the same or similar to the other components that may be included in the computing system 10′ of FIG. 3A. Note that in the embodiment of the computing system 10″ illustrated in FIG. 3B, the various logic modules (e.g., the bidding tag transmitting module 102″, the bid acquiring module 104″, and the content providing module 106″) may be implemented by the one or more processors 116 (or other types of circuitry such as field programmable gate arrays or FPGAs) executing one or more computer readable instructions 152 stored in memory 114.

In various embodiments, the memory 114 of the computing system 10′ of FIG. 3A and the computing system 10″ of FIG. 3B may comprise of one or more of mass storage device, read-only memory (ROM), programmable read-only memory (PROM), erasable programmable read-only memory (EPROM), cache memory such as random access memory (RAM), flash memory, synchronous random access memory (SRAM), dynamic random access memory (DRAM), and/or other types of memory devices.

Turning now to FIG. 4A illustrating a particular implementation of the bidding tag transmitting module 102* (e.g., the bidding tag transmitting module 102′ or the bidding tag transmitting module 102″) of FIGS. 3A and 3B. As illustrated, the bidding tag transmitting module 102* may include one or more sub-logic modules in various alternative implementations. For example, in various embodiments, the bidding tag transmitting module 102* may include a selection GUI data transmitting module 402, an access level identifying data transmitting module 404, a formula data transmitting module 406, a latency data and fee formula data transmitting module 408, a fee data and latency formula data transmitting module 410, a contextual information transmitting module 412, and/or a previous consumer information transmitting module 414. Specific details related to the bidding tag transmitting module 102* as well as the above-described sub-modules of the bidding tag transmitting module 102* will be provided below with respect to the operations and processes to be described herein.

FIG. 4B illustrates a particular implementation of the content providing module 106* (e.g., the content providing module 106′ or the content providing module 106″) of FIG. 3A or 3B. As illustrated, the content providing module 106* may include one or more sub-logic modules in various alternative embodiments. For example, in various embodiments, the content providing module 106* may include a content transmitting module 416, a content access providing module 418, a content access releasing instructions providing module 420, a previous consumer information providing module 422, a contextual information providing module 424, a news content providing module 426, a consumable media providing module 428, a content presentation option GUI data providing module 430, a contextual data presentation option GUI data providing module 432, and/or a previous consumer information presentation option GUI data providing module 434. Specific details related to the content providing module 106*, as well as the above-described sub-modules of the content providing module 106*, will be provided below with respect to the operations and processes to be described herein.

A more detailed discussion related to the computing system 10* (e.g., the computing system 10′ of FIG. 3A or the computing system 10″ of FIG. 3B) discussed above will now be provided with respect to the processes and operations to be described herein. FIG. 5 illustrates an operational flow 500 representing example operations for, among other things, releasing of a particular content in accordance with one or more bids 40 for accessing the particular content that was obtained as a result, at least in part, of communicating at least one bidding tag 30 to a plurality of client computing devices 60*, where the at least one bidding tag 30 to be communicated being designed to elicit the one or more bids 40 for accessing the content 20 that is being offered for consumption at different levels of access for accessing the content 20. In various implementations, these operations may be implemented by the computing system 10* of FIG. 3A or 3B (as well as FIG. 1).

In FIG. 5 and in the following figures that include various examples of operational flows, discussions and explanations will be provided with respect to the computing system 10* described above and as illustrated in FIGS. 3A, 3B, 4A, 4B, and/or with respect to other examples (e.g., as provided in FIGS. 1, 2A, 2B, 2C, 2D, 2E, 2F, 2G, 2H, 2J, 2K, and 2M) and contexts. However, it should be understood that the operational flows may be executed in a number of other environments and contexts, and/or in modified versions of FIGS. 1, 2A, 2B, 2C, 2D, 2E, 2F, 2G, 2H, 2J, 2K, 2M, 3A, 3B, 4A, and/or 4B. Also, although the various operational flows are presented in the sequence(s) illustrated, it should be understood that the various operations may be performed in orders other than those which are illustrated, or may be performed concurrently.

Further, in FIG. 5 and in the figures to follow thereafter, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently. Still further, these operations illustrated in FIG. 5 as well as the other operations to be described herein are performed by at least one of a machine, an article of manufacture, or a composition of matter unless indicated otherwise.

For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

In any event, after a start operation, the operational flow 500 of FIG. 5 may move to a bidding tag communicating operation 502 for communicating to two or more client computing devices at least one bidding tag that is designed to elicit one or more bids for accessing a content that is being offered for consumption at different levels of access for accessing the content, each of the different levels of access for accessing the content that is being offered for consumption being associated with a different content access latency and associated fee pair, and the at least one bidding tag to be communicated at least partially identifying the content to be offered for consumption. For instance, and as illustration, the bidding tag transmitting module 102* of the computing system 10* of FIG. 3A or 3B (e.g., the bidding tag transmitting module 102′ of FIG. 3A or the bidding tag transmitting module 102″ of FIG. 3B) communicating (e.g., transmitting) to two or more client computing devices 60* at least one bidding tag 30 that is designed to elicit one or more bids 40 for accessing a content 20 (e.g., news content such as financial/market news or consumable media such as feature length movie or a recording of a sports event) that is being offered for consumption through, for example, the at least one bidding tag 30 at different levels of access for accessing the content 20, each of the different levels of access for accessing the content 20 that is being offered for consumption being associated with a different content access latency and associated fee pair (e.g., a first level of content access associated with a first content access latency and a first fee, a second level of content access being associated with a second content access latency and a second fee, and so forth), and the at least one bidding tag 30 to be communicated at least partially identifying (e.g., directly or indirectly identifying) the content 20 to be offered for consumption.

Operational flow 500 may also include a bid obtaining operation 504 for obtaining one or more bids as a result, at least in part, of communicating the at least one bidding tag to the two or more client computing devices, the one or more bids to be obtained being at least one or more requests for accessing the content at one or more levels of the different levels of access for accessing the content that is being offered for consumption. For instance, the bid acquiring module 104* (e.g., the bid acquiring module 104′ of FIG. 3A or the bid acquiring module 104″ of FIG. 3B) of the computing system 10* of FIG. 3A or 3B obtaining one or more bids 40 as a result, at least in part, of communicating the at least one bidding tag 30 to the two or more client computing devices 60*, the one or more bids 40 to be obtained (e.g., obtained from one or more of the two or more client computing devices 60* that acquired the at least one bidding tag 30) being at least one or more requests for accessing the content 20 at one or more levels of the different levels of access for accessing the content 20 that is being offered for consumption (e.g., being offered for consumption through the at least one bidding tag 30 that was communicated to the two or more client computing devices 60*).

As further illustrated in FIG. 5, operational flow 500 may also include a content releasing operation 506 for releasing the content in accordance with the one or more obtained bids. For instance, the content providing module 106* (e.g., content providing module 106′ of FIG. 3A or the content providing module 106″ of FIG. 3B) of the computing system 10* of FIG. 3A or 3B releasing (e.g., providing) the content 20 to, for example, one or more client computing devices 60* in accordance with the one or more obtained bids 40.

As will be described below, the bidding tag communicating operation 502, the bid obtaining operation 504, and the content releasing operation 506 may be executed in a variety of different ways in various alternative implementations. FIGS. 6A, 6B, 6C, 6D, 6E, 6F, 6G, 6H, 6J, and 6K for example, illustrate at least some of the alternative ways that the bidding tag communicating operation 502 of FIG. 5 may be executed in various alternative implementations. In some cases, for example, the bidding tag communicating operation 502 may actually include or involve an operation 602 for communicating the at least one bidding tag to the two or more client computing devices via one or more wireless and/or wired networks as illustrated in FIG. 6A. For instance, the bidding tag transmitting module 102* of the computing system 10* (e.g., the computing system 10′ of FIG. 3A or the computing system 10″ of FIG. 3B) communicating the at least one bidding tag 30 to the two or more client computing devices 60* via one or more wireless and/or wired network(s) 5 (e.g., cellular data network, WLAN, WiMAX, PTSN, and so forth) using, for example, a network interface 112 (e.g., one or more network interface cards).

As further illustrated in FIG. 6A, in the same or alternative implementations, the bidding tag communicating operation 502 may additionally or alternatively include an operation 603 for communicating to the two or more client computing devices the at least one bidding tag by communicating to each of the two or more client computing devices at least an electronic copy of the at least one bidding tag. For instance, the bidding tag transmitting module 102* of the computing system 10* of FIG. 3A or 3B communicating to the two or more client computing devices 60* the at least one bidding tag 30 by communicating (e.g., transmitting) to each of the two or more client computing devices 60* (e.g., one or more mobile computing devices such as tablet computers and/or Smartphones, workstations, electronic trading platforms such as Bloomberg terminals, and/or other types of computing devices) at least an electronic copy of the at least one bidding tag 30.

A variety of ways may be employed in order to at least partially identify the content 20 to be offered for consumption. For example, in some cases, the bidding tag communicating operation 502 may actually include or involve an operation 604 for communicating to the two or more client computing devices the at least one bidding tag that at least partially identifies the content to be offered for consumption by communicating to the two or more client computing devices at least one bidding tag that at least identifies the content being offered for consumption is news content. For instance, the bidding tag transmitting module 102* of the computing system 10* of FIG. 3A or 3B communicating to the two or more client computing devices 60* the at least one bidding tag 30 that at least partially identifies (e.g., directly or indirectly identifies) the content 20 to be offered for consumption by communicating (e.g., transmitting) to the two or more client computing devices 60* at least one bidding tag 30 that at least identifies the content being offered for consumption through, for example, the at least one bidding tag 30 is news content (e.g., sports news, entertainment news, agricultural news, and so forth). In some cases, the partial identification of the content 20 may be made by using one or more codes to identity content 20. For example, a digital code such as 0010 may indicate news, while a digital code 0111 may indicate consumable media such as a movie.

As further illustrated in FIG. 6A, operation 604 may include one or more additional operations in various alternative implementations including, in some cases, an operation 605 for communicating to the two or more client computing devices the at least one bidding tag that at least identifies the content being offered for consumption is news content by communicating to the two or more client computing devices at least one bidding tag that at least identifies the content being offered for consumption as being business, financial, and/or market news. For instance, the bidding tag transmitting module 102* of the computing system 10* of FIG. 3A or 3B communicating to the two or more client computing devices 60* the at least one bidding tag 30 that at least identifies the content 20 being offered for consumption is news content by communicating to the two or more client computing devices 60* at least one bidding tag 30 that at least identifies the content 20 being offered for consumption as being business, financial, and/or market news (e.g., price of a particular commodity or stock).

In some implementations, operation 604 may actually include or involve an operation 606 for communicating to the two or more client computing devices the at least one bidding tag that at least identifies the content being offered for consumption is news content by communicating to the two or more client computing devices at least one bidding tag that at least identifies the content being offered for consumption as being human interest news. For instance, the bidding tag transmitting module 102* of the computing system 10* of FIG. 3A or 3B communicating to the two or more client computing devices 60* the at least one bidding tag 30 that at least identifies the content 20 being offered for consumption is news content by communicating to the two or more client computing devices 60* at least one bidding tag 30 that at least identifies the content 20 being offered for consumption as being human interest news (e.g., news related to a particular person or persons such as celebrities, or news related to a natural disaster or a societal event).

In some implementations, operation 606 may further include or involve an operation 607 for communicating to the two or more client computing devices the at least one bidding tag that at least identifies the content being offered for consumption as being human interest news by communicating to the two or more client computing devices at least one bidding tag that at least identifies the content being offered for consumption as being celebrity news. For instance, the bidding tag transmitting module 102* of the computing system 10* of FIG. 3A or 3B communicating to the two or more client computing devices 60* the at least one bidding tag 30 that at least identifies the content 20 being offered for consumption as being human interest news by communicating to the two or more client computing devices 60* at least one bidding tag that at least identifies the content 20 being offered for consumption as being celebrity news (e.g., identifying that the content 20 is celebrity news related to “Lindsey Lohan”).

In some implementations, operation 604 may actually involve or include an operation 608 for communicating to the two or more client computing devices the at least one bidding tag that at least identifies the content being offered for consumption is news content by communicating to the two or more client computing devices at least one bidding tag that at least identifies the content being offered for consumption as being political, governmental, and/or regulatory news. For instance, the bidding tag transmitting module 102* of the computing system 10* of FIG. 3A or 3B communicating to the two or more client computing devices 60* the at least one bidding tag 30 that at least identifies the content 20 being offered for consumption is news content by communicating to the two or more client computing devices 60* at least one bidding tag 30 that at least identifies the content 20 being offered for consumption as being political, governmental, and/or regulatory news (e.g., news related to interest rates as set forth by the Federal Reserve).

In the same or alternative implementations, the bidding tag communicating operation 502 may additionally or alternatively include an operation 609 for communicating to the two or more client computing devices the at least one bidding tag that at least partially identifies the content to be offered for consumption by communicating to the two or more client computing devices at least one bidding tag that at least identifies the content being offered for consumption is consumable media as illustrated in FIG. 6B. For instance, the bidding tag transmitting module 102* of the computing system 10* of FIG. 3A or 3B communicating to the two or more client computing devices 60* the at least one bidding tag 30 that at least partially identifies the content 20 to be offered for consumption by communicating (e.g., transmitting) to the two or more client computing devices 60* at least one bidding tag 30 that at least identifies the content 20 being offered for consumption is consumable media (e.g., a recording of a sporting event or concert, a documentary, and so forth).

In some implementations, operation 609 may actually include or involve an operation 610 for communicating to the two or more client computing devices the at least one bidding tag that at least identifies the content being offered for consumption is consumable media by communicating to the two or more client computing devices at least one bidding tag that at least identifies the content being offered for consumption as being a textual document, a video, or an audio recording. For instance, the bidding tag transmitting module 102* of the computing system 10* of FIG. 3A or 3B communicating to the two or more client computing devices 60* the at least one bidding tag 30 that at least identifies the content 20 being offered for consumption is consumable media by communicating to the two or more client computing devices 60* at least one bidding tag 30 that at least identifies the content 20 being offered for consumption as being (including) a textual document, a video, or an audio recording. For example, transmitting a bidding tag 30 that indicates the name of a particular feature length movie that is being offered for consumption.

In some embodiments, the bidding tag communicating operation 502 of FIG. 5 may actually involve communicating to the two or more client computing devices 60* data that at least facilitates the remote generation of a graphical user interface GUI at the two or more client computing devices 60* in order to elicit one or more bids (e.g., elicit one or more bids from one or more content consumers 62* who have access to the two or more client computing devices 60*) for accessing the content 20 that is being offered for consumption. For example, and as illustrated in FIGS. 6B, 6C, 6D, 6E, 6F, 6G, and 6H, the bidding tag communicating operation 502 may actually involve or include an operation 611 for communicating to the two or more client computing devices the at least one bidding tag that is designed to elicit the one or more bids for accessing the content by communicating to the two or more client computing devices data that at least facilitates visual generation of at least one selection graphical user interface (selection GUI) that is designed for selecting a particular level of access for accessing the content from the different levels of access for accessing the content. For instance, the bidding tag transmitting module 102* including the selection GUI data transmitting module 402 (see FIG. 4A) of the computing system 10* of FIG. 3A or 3B communicating to the two or more client computing devices 60* the at least one bidding tag 30 that is designed to elicit the one or more bids for accessing the content by communicating (e.g., transmitting) to the two or more client computing devices 60* data 32 that at least facilitates visual generation at the two or more client computing devices 60* of at least one selection graphical user interface (selection GUI) that is designed for selecting a particular level of access for accessing the content 20 from the different levels of access for accessing the content 20. Note that in some implementations, the data 32 that is communicated (e.g., transmitted) may comprise the complete or entire information needed for generating the selection GUI (e.g., the selection GUI 200a of FIG. 2A or the selection GUI 200b of FIG. 2B), while in other implementations, the data 32 that is communicated may only include certain selective information (e.g., latencies, fees, name of content, etc.) that may be needed in order to generate a selection GUI (e.g., selection GUI 200a or 200b of FIG. 2A or 2B). In some implementations, the data 32 that may be communicated or transmitted that at least facilitates generation of the selection GUI may or may not be part of the bidding tag 30 that is received by the computing system 10*.

As further illustrated in FIG. 6B, operation 611 in various implementations may further include or involve one or more additional operations including, in some cases, an operation 612 for communicating to the two or more client computing devices the data that at least facilitates visual generation of the at least one selection GUI that is designed for selecting the particular level of access for accessing the content from the different levels of access for accessing the content by communicating to the two or more client computing devices data that at least facilitates visual generation at the two or more client computing devices that receives the data of at least one selection GUI that is designed for selecting a particular level of access for accessing the content from the different levels of access for accessing the content. For instance, the selection GUI data transmitting module 402 of the computing system 10* of FIG. 3A or 3B communicating to the two or more client computing devices 60* the data 32 that at least facilitates visual generation at the two or more client computing devices 60* of the at least one selection graphical user interface (selection GUI) that is designed for selecting the particular level of access for accessing the content 20 from the different levels of access for accessing the content 20 by communicating (e.g., transmitting) to the two or more client computing devices 60* data 32 that at least facilitates visual generation at the two or more client computing devices 60* of at least one selection GUI (e.g., selection GUI) that is designed for selecting a particular level of access for accessing the content 20 from the different levels of access for accessing the content 20.

In some implementations, operation 611 may additionally or alternatively include an operation 613 for communicating to the two or more client computing devices the data that at least facilitates visual generation of the at least one selection GUI that is designed for selecting a particular level of access for accessing the content from the different levels of access for accessing the content by communicating to the two or more client computing devices data that at least facilitates visual generation of a selection GUI that includes a slider feature having an elongated element and a slider icon that is designed to be moveable, in response to user input, along length of the elongated element having a first end and a second end at opposite ends of the length of the elongated element, the slider icon being designed to be moved along the length of the elongated element from the first end to the second end to select the level of access for accessing the content as illustrated in FIG. 6C. For instance, the selection GUI data transmitting module 402 of the computing system 10* of FIG. 3A or 3B communicating to the two or more client computing devices 60 the data 32 that at least facilitates visual generation of the at least one selection GUI that is designed for selecting a particular level of access for accessing the content 20 from the different levels of access for accessing the content by communicating to the two or more client computing devices 60* data 32 that at least facilitates visual generation at the two or more client computing devices 60* of a selection GUI (e.g., selection GUI 200a of FIG. 2A) that includes a slider feature 201a having an elongated element 204a and a slider icon 202a that is designed to be moveable, in response to user input (e.g., user input as provided through a touchscreen or via mouse), along length of the elongated element 204a having a first end 208a and a second end 210a at opposite ends of the length of the elongated element 204a, the slider icon 202a being designed to be moved along the length of the elongated element 204a from the first end 208a to the second end 210a to select the level of access for accessing the content 20.

In some implementations, operation 613 may further include an operation 614 for communicating to the two or more client computing devices data that at least facilitates visual generation of a selection GUI that includes the slider feature having the elongated element and the slider icon by communicating to the two or more client computing devices data that at least facilitates visual generation of a slider feature that includes a slider icon that is designed to be moveable, in response to user input, along the length of the elongated element having a first end and a second end and having multiple points along the length of the elongated element including the first end and the second end, the multiple points along the length of the elongated element from the first end to the second end being associated with graduated levels of access for accessing the content with varying amounts of latencies for accessing the content and varying amounts of associated fees, the first end corresponding to highest level of access that is available along the elongated element for accessing the content with lowest amount of latency and highest fee that are available along the elongated element and the second end corresponding to lowest access available along the elongated element for accessing the content with highest amount of latency and lowest fee that are available along the elongated element, and each point along the elongated element from the second end to the first end corresponding to incrementally increasing levels of access for accessing the content with decreasing amounts of latencies and increasing amounts of associated fees. For instance, the selection GUI data transmitting module 402 of the computing system 10* of FIG. 3A or 3B communicating to the two or more client computing devices 60* data 32 that at least facilitates visual generation of a selection GUI 200a that includes the slider feature 201a having the elongated element 204a and the slider icon 202a by communicating to the two or more client computing devices 60* data 32 that at least facilitates visual generation at the two or more client computing devices 60* of a slider feature 201a (see FIG. 2A) that includes a slider icon 202a that is designed to be moveable, in response to user input, along the length of the elongated element 204a having a first end 208a and a second end 210a and having multiple points 212 along the length of the elongated element 204a including the first end 208a and the second end 210a, the multiple points 212a along the length of the elongated element 204a from the first end 208a to the second end 210a being associated with graduated levels of access for accessing the content 20 with varying amounts of latencies (e.g., time delays) for accessing the content 20 and varying amounts of associated fees, the first end 208a corresponding to highest level of access that is available along the elongated element 204a for accessing the content 20 with lowest amount of latency and highest fee that are available along the elongated element 204a and the second end 210a corresponding to lowest access available along the elongated element 204a for accessing the content 20 with highest amount of latency and lowest fee that are available along the elongated element 204a, and each point 212a along the elongated element 204a from the second end 210a to the first end 208a corresponding to incrementally increasing levels of access for accessing the content 20 with decreasing amounts of latencies and increasing amounts of associated fees.

In the same or alternative implementations, operation 613 may additionally or alternatively include an operation 615 for communicating to the two or more client computing devices data that at least facilitates visual generation of a selection GUI that includes the slider feature having the elongated element and the slider icon by communicating to the two or more client computing devices data that at least facilitates visual generation of a slider feature having an elongated element and a slider icon that is designed to be moveable, in response to user input, along the length of the elongated element having at least a first end and a second end and having at least three points along the length of the elongated element including the first end, the second end, and at least a third point between the first end and the second end, each of the at least three points along the length of the elongated element from the first end to the second end being associated with a different level of access for accessing the content with a different amount of latency for accessing the content and different amount of associated fee as illustrated in FIG. 6D. For instance, the selection GUI data transmitting module 402 of the computing system 10* of FIG. 3A or 3B communicating to the two or more client computing devices 60* data 32 that at least facilitates visual generation of a selection GUI 200a that includes the slider feature 201a having the elongated element 204a and the slider icon 202a by communicating to the two or more client computing devices 60* data 32 that at least facilitates visual generation at the two or more client computing devices 60* of a slider feature 201a having an elongated element 204a and a slider icon 202a that is designed to be moveable, in response to user input, along the length of the elongated element 204a having at least a first end 208a and a second end 210a and having at least three points along the length of the elongated element 204a including the first end 208a, the second end 210a, and at least a third point 212a between the first end 208a and the second end 210a, each of the at least three points along the length of the elongated element 204a from the first end 208a to the second end 210a being associated with a different level of access for accessing the content 20 with a different amount of latency for accessing the content 20 and different amount of associated fee.

As further illustrated in FIG. 6D, operation 615 may, in some implementations, further include an operation 616 for communicating to the two or more client computing devices data that at least facilitates visual generation of a slider feature having an elongated element and a slider icon that is designed to be moveable, in response to user input, along the length of the elongated element having at least 10 points along the length of the elongated element including a first end and a second end, each of the at least 10 points along the length of the elongated element from the first end to the second end being associated with a different level of access for accessing the content with a different amount of latency for accessing the content and different amount of associated fee. For instance, the selection GUI data transmitting module 402 of the computing system 10* of FIG. 3A or 3B communicating to the two or more client computing devices 60* data 32 that at least facilitates visual generation of a slider feature 201a (see FIG. 2A) having an elongated element 204a and a slider icon 202a that is designed to be moveable, in response to user input, along the length of the elongated element 204a having at least 10 points (e.g., multiple points 212a) along the length of the elongated element 204a including a first end 208a and a second end 210a, each of the at least 10 points along the length of the elongated element 204a from the first end 208a to the second end 210a being associated with a different level of access for accessing the content 20 with a different amount of latency for accessing the content 20 and different amount of associated fee.

Turning now to FIG. 6E, in some implementations, operation 615 may include an operation 617 for communicating to the two or more client computing devices data that at least facilitates visual generation of a slider feature having an elongated element and a slider icon that is designed to be moveable, in response to user input, along the length of the elongated element having at least 30 points along the length of the elongated element including a first end and a second end, each of the at least 30 points along the length of the elongated element from the first end to the second end being associated with a different level of access for accessing the content with a different amount of latency for accessing the content and different amount of associated fee. For instance, the selection GUI data transmitting module 402 of the computing system 10* of FIG. 3A or 3B communicating to the two or more client computing devices 60* data 32 that at least facilitates visual generation of a slider feature 201a (see FIG. 2A) having an elongated element 204a and a slider icon 202a that is designed to be moveable, in response to user input, along the length of the elongated element 204a having at least 30 points (e.g., multiple points 212a) along the length of the elongated element 204a including a first end 208a and a second end 210a, each of the at least 30 points along the length of the elongated element 204a from the first end 208a to the second end 210a being associated with a different level of access for accessing the content 20 with a different amount of latency for accessing the content 20 and different amount of associated fee.

In some implementations, operation 611 for communicating to the two or more client computing devices the at least one bidding tag that is designed to elicit the one or more bids for accessing the content by communicating to the two or more client computing devices data that at least facilitates visual generation of at least one selection graphical user interface (selection GUI) that is designed for selecting a particular level of access for accessing the content from the different levels of access for accessing the content may actually include or involve an operation 618 for communicating to the two or more client computing devices data that at least facilitates the visual generation of the at least one selection GUI by communicating to the two or more client computing devices data that at least facilitates visual generation of a plurality of icons that are designed to be used for selecting a specific level of access for accessing the content from the different levels of access for accessing the content, each of the plurality of icons to be generated being associated with a different level of access for accessing the content with a different amount of latency for accessing the content and different amount of associated fee as illustrated in FIG. 6F. For instance, the selection GUI data transmitting module 402 of the computing system 10* of FIG. 3A or 3B communicating to the two or more client computing devices 60* data 32 that at least facilitates the visual generation of the at least one selection GUI by communicating (e.g., transmitting) to the two or more client computing devices 60* data 32 that at least facilitates visual generation at the two or more client computing devices 60* of a plurality of icons 220b (see FIG. 2B) that are designed to be used for selecting a specific level of access for accessing the content 20 from the different levels of access for accessing the content 20, each of the plurality of icons 220b to be generated being associated with a different level of access for accessing the content 20 with a different amount of latency for accessing the content 20 and different amount of associated fee.

As further illustrated in FIG. 6F, in various implementations, operation 618 may actually include or involve one or more additional operations including in some cases an operation 619 for communicating to the two or more client computing devices the data that at least facilitates visual generation of the plurality of icons by communicating to the two or more client computing devices data that at least facilitates visual generation of a plurality of button icons that are designed to be used for selecting the specific level of access for accessing the content from the different levels of access for accessing the content. For instance, the selection GUI data transmitting module 402 of the computing system 10* of FIG. 3A or 3B communicating to the two or more client computing devices 60* the data 32 that at least facilitates visual generation of the plurality of icons 220b by communicating to the two or more client computing devices 60* data 32 that at least facilitates visual generation of a plurality of button icons (e.g., icons 220b of FIG. 2B) that are designed to be used for selecting the specific level of access for accessing the content from the different levels of access for accessing the content 20.

In some cases, operation 618 may actually involve or include an operation 620 for communicating to the two or more client computing devices the data that at least facilitates visual generation of the plurality of icons by communicating to the two or more client computing devices data that at least facilitates visual generation of at least three icons that are designed to be used for selecting the specific level of access for accessing the content from the different levels of access for accessing the content, each of the at least three icons to be generated being associated with a different level of access for accessing the content with a different amount of latency for accessing the content and different amount of associated fee. For instance, the selection GUI data transmitting module 402 of the computing system 10* of FIG. 3A or 3B communicating to the two or more client computing devices 60* the data 32 that at least facilitates visual generation of the plurality of icons 220b by communicating to the two or more client computing devices 60* data 32 that at least facilitates visual generation of at least three icons 220b that are designed to be used for selecting the specific level of access for accessing the content 20 from the different levels of access for accessing the content 20, each of the at least three icons 220b to be generated being associated with a different level of access for accessing the content 20 with a different amount of latency for accessing the content 20 and different amount of associated fee.

In some cases, operation 618 may actually involve or include an operation 621 for communicating to the two or more client computing devices the data that at least facilitates visual generation of the plurality of icons by communicating to the two or more client computing devices data that at least facilitates visual generation of at least ten icons that are designed to be used for selecting the specific level of access for accessing the content from the different levels of access for accessing the content, each of the at least ten icons to be generated being associated with a different level of access for accessing the content with a different amount of latency for accessing the content and different amount of associated fee. For instance, the selection GUI data transmitting module 402 of the computing system 10* of FIG. 3A or 3B communicating to the two or more client computing devices 60* the data 32 that at least facilitates visual generation of the plurality of icons 220b by communicating to the two or more client computing devices 60* data 32 that at least facilitates visual generation of at least ten icons 220b (see FIG. 2B) that are designed to be used for selecting the specific level of access for accessing the content 20 from the different levels of access for accessing the content 20, each of the at least ten icons 220b to be generated being associated with a different level of access for accessing the content 20 with a different amount of latency (e.g., no delay, one week, two weeks, and so forth) for accessing the content 20 and different amount of associated fee (e.g., $100, $90, and so forth—the shorter the latency the higher the associated fee).

Turning now to FIG. 6G, in some implementations, operation 611 for communicating to the two or more client computing devices the at least one bidding tag that is designed to elicit the one or more bids for accessing the content by communicating to the two or more client computing devices data that at least facilitates visual generation of at least one selection graphical user interface (selection GUI) that is designed for selecting a particular level of access for accessing the content from the different levels of access for accessing the content may actually include or involve an operation 622 for communicating to the two or more client computing devices the data that at least facilitates the visual generation of the at least one selection GUI by communicating to the two or more client computing devices data that at least facilitates visual generation of at least one selection GUI that includes an option for obtaining and/or presenting contextual information related to the content. For instance, the selection GUI data transmitting module 402 of the computing system 10* of FIG. 3A or 3B transmitting the data that at least facilitates generation of the selection GUI 200a by communicating to the two or more client computing devices 60* the data 32 that at least facilitates the visual generation of the at least one selection GUI 200a by communicating (e.g., transmitting) to the two or more client computing devices 60* data 32 that at least facilitates visual generation at the two or more client computing devices 60* of at least one selection GUI 200a (see FIG. 2A) that includes an option (e.g., icon 209a which may be selected by “tapping” the icon 209a on a touchscreen or “clicking” the icon 209a using a mouse) for obtaining and/or presenting contextual information (e.g., historical market information, movie trailers, etc.) related to the content 20. For example, icon 209a may be tapped or clicked in order to retrieve and/or present historical market data related to content 20 (e.g., market or share price information).

As further illustrated in FIG. 6G, in some cases, operation 622 may further include or involve an operation 623 for communicating to the two or more client computing devices the data that at least facilitates the visual generation of the at least one selection GUI that includes the option for obtaining and/or presenting contextual information related to the content by communicating to the two or more client computing devices data that at least facilitates visual generation of at least one selection GUI that includes an option for obtaining and/or presenting historical background information related to the content. For instance, the selection GUI data transmitting module 402 of the computing system 10* of FIG. 3A or 3B communicating to the two or more client computing devices 60* the data 32 that at least facilitates the visual generation of the at least one selection GUI 200a that includes the option (e.g., icon 209a of FIG. 2A) for obtaining and/or presenting contextual information related to the content 20 by communicating to the two or more client computing devices 60* data 32 that at least facilitates visual generation of at least one selection GUI 200a that includes an option (e.g., icon 209a) for obtaining and/or presenting historical background information (e.g., historical stock market information) related to the content 20 (e.g., stock market news).

In the same or alternative implementations, operation 611 may include an operation 624 for communicating to the two or more client computing devices the data that at least facilitates visual generation of the at least one selection GUI by communicating to the two or more client computing devices data that at least facilitates visual generation of at least one selection GUI that includes an option for obtaining and/or presenting previous consumer information related to one or more content consumers who have previously accessed the content as illustrated in FIG. 6H. For instance, the selection GUI data transmitting module 402 of the computing system 10* of FIG. 3A or 3B communicating to the two or more client computing devices 60* the data 32 that at least facilitates visual generation of the at least one selection GUI 200a by communicating (e.g., transmitting) to the two or more client computing devices 60* data 32 that at least facilitates visual generation at the two or more client computing devices 60*of at least one selection GUI 200a (see FIG. 2A) that includes an option (e.g., icon 207a of FIG. 2A which may be selected by “tapping” the icon 207a on a touchscreen or “clicking” the icon 207a using a mouse) for obtaining and/or presenting previous consumer information related to one or more content consumers 62* who have previously accessed the content 20.

In some cases, operation 624 may, in turn, include or involve an operation 625 for communicating to the two or more client computing devices the data that at least facilitates visual generation of at least one selection GUI that includes an option for obtaining and/or presenting previous consumer information related to one or more content consumers who have previously accessed the content by communicating to the two or more client computing devices data that at least facilitates visual generation of at least one selection GUI that includes an option for obtaining and/or presenting information that identifies the one or more content consumers who have previously accessed the content and/or the number of one or more content consumers who have previously accessed the content. For instance, the selection GUI data transmitting module 402 of the computing system 10* of FIG. 3A or 3B communicating to the two or more client computing devices 60* the data 32 that at least facilitates visual generation of at least one selection GUI 200a that includes an option for obtaining and/or presenting previous consumer information related to one or more content consumers 62* who have previously accessed the content 20 by communicating to the two or more client computing devices 60* data 32 that at least facilitates visual generation of at least one selection GUI 200a (see FIG. 2A) that includes an option (e.g., icon 207a) for obtaining and/or presenting information that identifies the one or more content consumers 62* who have previously accessed the content 20 and/or the number of one or more content consumers 62* who have previously accessed the content 20. For example, identifying which content consumers 62* have already accessed prices of stocks that were disclosed by the content 20 and/or the number of users (e.g., content consumers 62*) who have already viewed such information.

In some implementations, operation 624 may include or involve an operation 626 for communicating to the two or more client computing devices the data that at least facilitates visual generation of at least one selection GUI that includes an option for obtaining and/or presenting previous consumer information related to one or more content consumers who have previously accessed the content by communicating to the two or more client computing devices data that at least facilitates visual generation of at least one selection GUI that includes an option for obtaining and/or presenting information that indicates when and/or how the one or more content consumers who have previously accessed the content actually accessed the content. For instance, the selection GUI data transmitting module 402 of the computing system 10* of FIG. 3A or 3B communicating to the two or more client computing devices 60* the data 32 that at least facilitates visual generation of at least one selection GUI 200a that includes an option for obtaining and/or presenting previous consumer information related to one or more content consumers 62* who have previously accessed the content 20 by communicating to the two or more client computing devices 60* data 32 that at least facilitates visual generation of at least one selection GUI that includes an option (e.g., icon 207a) for obtaining and/or presenting information that indicates when and/or how (e.g., what type of communication network or link) the one or more content consumers 62* who have previously accessed the content 20 actually accessed the content 20.

Referring now to FIG. 6J, in some implementations, the bidding tag communicating operation 502 may include or involve an operation 627 for communicating to the two or more client computing devices the at least one bidding tag that is designed to elicit one or more bids for accessing a content that is being offered for consumption at different levels of access for accessing the content by communicating to the two or more client computing devices data that identifies the different levels of access for accessing the content including identifying for each level of access for accessing the content a corresponding content access latency and associated fee pair. For instance, the bidding tag transmitting module 102* including the access level identifying data transmitting module 404 (see FIG. 4A) of the computing system 10* of FIG. 3A or 3B communicating to the two or more client computing devices 60* the at least one bidding tag 30 that is designed to elicit one or more bids 40 for accessing a content 20 that is being offered for consumption at different levels of access for accessing the content when the access level identifying data relaying transmitting module 404 communicates to the two or more client computing devices 60* data 32 that identifies the different levels of access for accessing the content 20 including identifying for each level of access for accessing the content 20 a corresponding content access latency and associated fee pair (e.g., identifying for a first level of content access a corresponding first content access latency and a first associated fee, identifying for a second level of content access a corresponding second content access latency and a second associated fee, and so forth).

In some implementations, operation 627 may actually include or involve an operation 628 for communicating to the two or more client computing devices the data that identifies the different levels of access for accessing the content by communicating to the two or more client computing devices data that identifies for at least three different levels of access for accessing the content at least three corresponding content access latency and associated fee pairs. For instance, the access level identifying data transmitting module 404 of the computing system 10* of FIG. 3A or 3B communicating to the two or more client computing devices 60* the data 32 that identifies the different levels of access for accessing the content by communicating to the two or more client computing devices 60* data 32 that identifies for at least three different levels of access for accessing the content 20 at least three corresponding content access latency and associated fee pairs (e.g., communicating data 32 that identifies for a first level of content access a first latency/fee pair, for a second level of content access a second latency/fee pair, and for a third level of content access a third latency/fee pair).

In other implementations, operation 627 may alternatively include or involve an operation 629 for communicating to the two or more client computing devices the data that identifies the different levels of access for accessing the content by communicating to the two or more client computing devices data that identifies for at least ten different levels of access for accessing the content at least ten corresponding content access latency and associated fee pairs. For instance, the access level identifying data transmitting module 404 of the computing system 10* of FIG. 3A or 3B communicating to the two or more client computing devices 60* the data 32 that identifies the different levels of access for accessing the content 20 by communicating to the two or more client computing devices 60* data 32 that identifies for at least ten different levels of access for accessing the content 20 at least ten corresponding content access latency and associated fee pairs.

In some cases, rather than communicating data that specifically identifies the latencies/fees associated with the different levels of content access, alternative data may be communicated that provides one or more formulas for generating the different latencies/fees associated with the differing levels of content access that may be made available through, for example, a selection GUI (e.g., the selection GUI 200a or the selection GUI 200b of FIG. 2A or 2B) that may be presented by, for example, the one or more client computing devices 60* of FIG. 1 that may receive such data. For example, in some implementations, the bidding tag communicating operation 502 may additionally or alternatively include an operation 630 for communicating to the two or more client computing devices the at least one bidding tag that is designed to elicit one or more bids for accessing a content that is being offered for consumption at different levels of access for accessing the content by communicating to the two or more client computing devices data that provides one or more formulas designed to provide for each level of access for accessing the content, a corresponding content access latency and associated fee pair. For instance, the bidding tag transmitting module 102* including the formula data transmitting module 406 (see FIG. 4A) of the computing system 10* of FIG. 3A or 3B communicating to the two or more client computing devices 60* the at least one bidding tag 30 that is designed to elicit one or more bids 40 for accessing a content 20 that is being offered for consumption at different levels of access for accessing the content 20 when the formula data transmitting module 406 communicates (e.g., transmits) to the two or more client computing devices 60* data 32 that provides one or more formulas designed to provide for each level of access for accessing the content 20, a corresponding content access latency and associated fee pair. For example, suppose the content 20 being offered for consumption is a feature length movie, and there are nth levels of content access available, then formula data could be communicated (e.g., transmitted) that provides the following formulas: latency=1 week*n and Fee=$54/n. Thus, in this example, the greater level of access (e.g., lower n value where n=1 is highest access level) the lower amount of latency and higher fee amount. For example, if n=1, latency would be one week, and the fee would be $54. If n=2, latency will be 2 weeks, and fee would be $27.

In some alternative implementations, the bidding tag communicating operation 502 may alternatively include an operation 631 for communicating to the two or more client computing devices the at least one bidding tag that is designed to elicit one or more bids for accessing a content that is being offered for consumption at different levels of access for accessing the content by communicating to the two or more client computing devices data that identifies different corresponding content access latencies for each of the different levels of access for accessing the content and data that identifies one or more formulas that when applied to each of the identified corresponding content access latencies provides an associated fee. For instance, the bidding tag transmitting module 102* including the latency data and fee formula data transmitting module 408 (see FIG. 4A) of the computing system 10* of FIG. 3A or 3B communicating to the two or more client computing devices 60* the at least one bidding tag 30 that is designed to elicit one or more bids 40 for accessing a content 20 that is being offered for consumption at different levels of access for accessing the content 20 when the latency data and fee formula data transmitting module 408 communicates (e.g., transmits) to the two or more client computing devices 60* data 32 that identifies different corresponding content access latencies for each of the different levels of access for accessing the content 20 and data 32 that identifies one or more formulas that when applied to each of the identified corresponding content access latencies provides an associated fee. For example, suppose the content 20 to be offered for consumption is again a movie, then the data 32 that may be communicated may indicate that the available latencies are one week, two weeks, three weeks, and so forth, and the data 32 may further identify a formula (e.g., fee=maximum fee/latency) for generating the associated fee for each available latency.

In some alternative implementations, the bidding tag communicating operation 502 may alternatively include an operation 632 for communicating to the two or more client computing devices the at least one bidding tag that is designed to elicit one or more bids for accessing a content that is being offered for consumption at different levels of access for accessing the content by communicating to the two or more client computing devices data that identifies associated fees for each of the different levels of access for accessing the content and data that identifies a formula that when applied to each of the identified associated fees provides a corresponding content access latency. For instance, the bidding tag transmitting module 102* including the fee data and latency formula data transmitting module 410 (see FIG. 4A) of the computing system 10* of FIG. 3A or 3B communicating to the two or more client computing devices 60* the at least one bidding tag 30 that is designed to elicit one or more bids 40 for accessing a content 20 that is being offered for consumption at different levels of access for accessing the content 20 when the fee data and latency formula data transmitting module 410 communicates (e.g., transmits) to the two or more client computing devices 60* data 32 that identifies associated fees for each of the different levels of access for accessing the content 20 and data 32 that identifies a formula that when applied to each of the identified associated fees provides a corresponding content access latency (e.g., content access time delays). For example, suppose the content 20 to be offered for consumption is again a movie, then transmitting data that indicates that the available fees are $54, $27, and so forth, and then receiving data that identifies a formula (e.g., latency=$54/fee) for generating the associated latency for each available fee.

In the same or alternative implementations, the bidding tag communicating operation 502 of FIG. 5 may additionally or alternatively include an operation 633 for communicating to the two or more client computing devices the at least one bidding tag including communicating to the two or more client computing devices contextual information related to the content that is being offered for consumption at different levels of access for accessing the content as illustrated in FIG. 6K. For instance, the bidding tag transmitting module 102* including the contextual information transmitting module 412 (see FIG. 4A) of the computing system 10* of FIG. 3A or 3B communicating to the two or more client computing devices 60* the at least one bidding tag 32 when the contextual information transmitting module 412 communicates (e.g., transmits) to the two or more client computing devices 60* contextual information (e.g., historical market or financial information or a movie trailer) related to the content 20 that is being offered for consumption at different levels of access for accessing the content 20.

In some implementations, operation 633 may actually involve an operation 634 for communicating to the two or more client computing devices the contextual information related to the content that is being offered for consumption at different levels of access for accessing the content by communicating to the two or more client computing devices historical background information related to the content. For instance, the contextual information transmitting module 412 of the computing system 10* of FIG. 3A or 3B communicating to the two or more client computing devices 60* the contextual information related to the content 20 that is being offered for consumption at different levels of access for accessing the content 20 by communicating to the two or more client computing devices 60* historical background information (e.g., historical market or financial information) related to the content 20.

In the same or alternative implementations, the bidding tag communicating operation 502 of FIG. 5 may additionally or alternatively include an operation 635 for communicating to the two or more client computing devices the at least one bidding tag including communicating to the two or more client computing devices previous consumer information related to one or more content consumers who have previously accessed the content. For instance, the bidding tag transmitting module 102* including the previous consumer information transmitting module 414 (see FIG. 4A) of the computing system 10* of FIG. 3A or 3B communicating to the two or more client computing devices 60* the at least one bidding tag 30 when the previous consumer information transmitting module 414 communicates (e.g., transmits) to the two or more client computing devices 60* previous consumer information (e.g., identity, when or how content was accessed, etc.) related to one or more content consumers 62* who have previously accessed the content 20. For example, communicating or transmitting to a subset of client computing devices (e.g., client computing devices 60c and 60d of FIG. 1) from the plurality of client computing devices 60* (e.g., client computing devices 60a, 60b, 60c, and 60d) illustrated in FIG. 1 previous consumer information related to one or more content consumers 62a and/or 62b who may have previously access the content 20.

As further illustrated in FIG. 6K, in some cases operation 635 may further include or involve an operation 636 for communicating to the two or more client computing devices the previous consumer information related to one or more content consumers who have previously accessed the content by communicating to the two or more client computing devices information that identifies the one or more content consumers who have previously accessed the content and/or the number of one or more content consumers who have previously accessed the content. For instance, the previous consumer information transmitting module 414 of the computing system 10* of FIG. 3A or 3B communicating to the two or more client computing devices 60c and 60d (see FIG. 1) the previous consumer information related to one or more content consumers (e.g., content consumer 62a and/or content consumer 62b) who have previously accessed the content 20 by communicating to the two or more client computing devices 60c and 60d information that identifies the one or more content consumers (e.g., content consumer 62a and/or content consumer 62b) who have previously accessed the content 20 and/or the number of one or more content consumers (e.g., content consumer 62a and/or 62b) who have previously accessed the content 20.

In the same or alternative implementations, operation 635 may additionally or alternatively include an operation 637 for communicating to the two or more client computing devices the previous consumer information related to one or more content consumers who have previously accessed the content by communicating to the two or more client computing devices information that indicates when and/or how the one or more content consumers who have previously accessed the content actually accessed the content. For instance, the previous consumer information transmitting module 414 of the computing system 10* of FIG. 3A or 3B communicating to the two or more client computing devices 60c and 60d the previous consumer information related to one or more content consumers 62a and/or 62b who have previously accessed the content 20 by communicating to the two or more client computing devices 60c and 60d information that indicates when and/or how the one or more content consumers 62a and/or 62b who have previously accessed the content 20 actually accessed the content 20.

Referring back to the bid obtaining operation 504 of FIG. 5, the bid obtaining operation 504 similar to the bidding tag communicating operation 502 of FIG. 5 may be executed in a number of different ways in various alternative embodiments as illustrated in FIGS. 7A, 7B, and 7C. In some implementations, for example, the bid obtaining operation 504 may include an operation 738 for obtaining the one or more bids by obtaining the one or more bids via one or more wireless and/or wired networks as illustrated in FIG. 7A. For instance, the bid acquiring module 104* of the computing system 10* of FIG. 3A or 3B obtaining the one or more bids 40 by obtaining (e.g., acquiring) the one or more bids 40 via one or more wireless and/or wired network(s) 5 (e.g., WLAN, WiMax, WMAN, cellular data network, PTSN, and so forth).

In the same or alternative implementations, the bid obtaining operation 504 may additionally or alternatively include an operation 739 for obtaining the one or more bids by obtaining the one or more bids from one or more of the two or more client computing devices. For instance, the bid acquiring module 104* of the computing system 10* of FIG. 3A or 3B obtaining the one or more bids 40 by obtaining (e.g., acquiring) the one or more bids 40 from one or more of the two or more client computing devices 60* (e.g., one or more desktop computers, workstations, mobile computing devices, electronic trading platforms such as Bloomberg terminals, and so froth) that the at least one bidding tag 30 was communicated or transmitted to.

In some cases, operation 739 may further include or involve an operation 740 for obtaining the one or more bids from the one or more of the two or more client computing devices by obtaining the one or more bids from one or more electronic trading platforms. For instance, the bid acquiring module 104* of the computing system 10* of FIG. 3A or 3B obtaining the one or more bids 40 from the one or more of the two or more client computing devices 60* by obtaining the one or more bids 40 from one or more electronic trading platforms (e.g., Bloomberg terminals).

In the same or alternative implementations, the bid obtaining operation 504 may additionally or alternatively include an operation 741 for obtaining the one or more bids by obtaining two more bids including at least a first bid that includes at least a request for accessing the content at a first level of access that is associated with a first amount of content access latency and a first amount of associated fee and a second bid that includes at least a request for accessing the content at a second level of access that is associated with a second amount of content access latency and a second amount of associated fee. For instance, the bid acquiring module 104* of the computing system 10* of FIG. 3A or 3B obtaining the one or more bids 40 by obtaining (e.g., acquiring) two more bids 40 including at least a first bid 40 that includes at least a request for accessing the content 20 at a first level of access that is associated with a first amount of content access latency and a first amount of associated fee and a second bid 40 that includes at least a request for accessing the content 20 at a second level of access that is associated with a second amount of content access latency and a second amount of associated fee.

As further illustrated in FIG. 7A, operation 741 may further include or involve one or more additional operations in various alternative implementations, For example, in some implementations, operation 741 may include an operation 742 for obtaining the two or more bids by obtaining a first bid that is at least a request for accessing the content at a first level of access that is associated with a first amount of content access latency and a first amount of associated fee and a second bid that is at least a request for accessing the content at a second level of access that is associated with a second amount of content access latency and a second amount of associated fee, where the first level of access and the second level of access being different. For instance, the bid acquiring module 104* of the computing system 10* of FIG. 3A or 3B obtaining the two or more bids 40 by obtaining a first bid 40 that is at least a request for accessing the content 20 at a first level of access that is associated with a first amount of content access latency and a first amount of associated fee and a second bid 40 that is at least a request for accessing the content 20 at a second level of access that is associated with a second amount of content access latency and a second amount of associated fee, where the first level of access and the second level of access being different (e.g., the first amount of content access latency and the first amount of associated fee being different from the second amount of content access latency and the second amount of associated fee).

In some implementations, operation 741 may include an operation 743 for obtaining the two or more bids by obtaining the first bid that includes at least a request for accessing the content at the first level of access that is associated with the first amount of content access latency and the first amount of associated fee and a third bid that includes at least a request for accessing the content at the first level of access that is associated with the first amount of content access latency and the first amount of associated fee. For instance, the bid acquiring module 104* of the computing system 10* of FIG. 3A or 3B obtaining the two or more bids 40 by obtaining the first bid 40 that includes at least a request for accessing the content 20 at the first level of access that is associated with the first amount of content access latency and the first amount of associated fee and a third bid 40 that includes at least a request that is the same as the request included in the first bid 40 for accessing the content 20 at the first level of access that is associated with the first amount of content access latency and the first amount of associated fee (e.g., the first bid 40 and the third bid 40 being two requests for accessing the content 20 at the same level of access—at the same amount of content access latency and the same amount of associated fee).

In some implementations, operation 741 may include an operation 744 for obtaining the two or more bids including at least the first bid that includes at least the request for accessing the content at the first level of access and the second bid that includes at least the request for accessing the content at the second level of access by further obtaining a third bid that includes at least a request for accessing the content at a third level of access that is associated with a third amount of content access latency and a third amount of associated fee. For instance, the bid acquiring module 104* of the computing system 10* of FIG. 3A or 3B obtaining the two or more bids 40 including at least the first bid 40 that includes at least the request for accessing the content 20 at the first level of access and the second bid 40 that includes at least the request for accessing the content 20 at the second level of access by further obtaining a third bid 40 that includes at least a request for accessing the content 20 at a third level of access that is associated with a third amount of content access latency and a third amount of associated fee.

In some cases, operation 744 may further include or involve an operation 745 for obtaining the first bid, the second bid, and the third bid by obtaining a first bid, a second bid, and a third bid that includes three different requests, respectively, for accessing the content at three different levels of access associated with three different content access latency/associated fee pairs. For instance, the bid acquiring module 104* of the computing system 10* of FIG. 3A or 3B obtaining the first bid 40, the second bid 40, and the third bid 40 by obtaining a first bid 40, a second bid 40, and a third bid 40 that includes three different requests, respectively, for accessing the content 20 at three different levels of access associated with three different content access latency/associated fee pairs.

Turning now to FIG. 7B, in some cases, a content consumer 62* may be able to submit multiple requests for accessing a content 20 at different levels of access. This may be done, for example, so that the content consumer 62 can provide a primary choice as well as secondary choices for accessing the content 20 (e.g., if the primary access level choice is not available, then the content consumer 62* may be granted his/her secondary access choice. For instance, if the content 20 to be offered for consumption is stock market data (e.g., price of a particular stock on a particular day), then in some cases, only a limited number of content consumers 62* may be allowed to access the content 20 at the lowest amount of latency (e.g., at the lowest delay time). Thus, in some implementations, the bid obtaining operation 504 may include an operation 746 for obtaining the one or more bids including obtaining at least one bid that includes at least a first request for accessing the content at a first level of access that is associated with a first amount of content access latency and a first amount of associated fee and a second request for accessing the content at a second level of access that is associated with a second amount of content access latency and a second amount of associated fee. For instance, the bid acquiring module 104* of the computing system 10* of FIG. 3A or 3B obtaining the one or more bids 40 including obtaining (e.g., acquiring) at least one bid 40 that includes at least a first request for accessing the content 20 at a first level of access that is associated with a first amount of content access latency and a first amount of associated fee and a second request for accessing the content 20 at a second level of access that is associated with a second amount of content access latency and a second amount of associated fee.

As further illustrated in FIG. 7B, in some implementations, operation 746 may further include an operation 747 for obtaining the at least one bid that includes at least the first request for accessing the content at the first level of access and the second request for accessing the content at the second level of access, where the first request being a preferred request over the second request, and where a preferred request being a request that is selected for, if possible, granting before granting a request that is less preferred. For instance, the bid acquiring module 104* of the computing system 10* of FIG. 3A or 3B obtaining the at least one bid 40 that includes at least the first request for accessing the content 20 at the first level of access and the second request for accessing the content 20 at the second level of access, where the first request being a preferred request over the second request, and where a preferred request being a request that is selected for, if possible (e.g., if available), granting before granting a request that is less preferred.

In the same or different implementations, operation 746 may additionally or alternatively include an operation 748 for obtaining the at least one bid that includes at least the first request for accessing the content at the first level of access and the second request for accessing the content at the second level of access by obtaining at least one bid that includes at least the first request for accessing the content at the first level of access that is associated with the first amount of content access latency and the first amount of associated fee, the second request for accessing the content at the second level of access that is associated with the second amount of content access latency and the second amount of associated fee, and a third request for accessing the content at a third level of access that is associated with a third amount of content access latency and a third amount of associated fee. For instance, the bid acquiring module 104* of the computing system 10* of FIG. 3A or 3B obtaining the at least one bid 40 that includes at least the first request for accessing the content 20 at the first level of access and the second request for accessing the content 20 at the second level of access by obtaining at least one bid 40 that includes at least the first request for accessing the content 20 at the first level of access that is associated with the first amount of content access latency and the first amount of associated fee, the second request for accessing the content 20 at the second level of access that is associated with the second amount of content access latency and the second amount of associated fee, and a third request for accessing the content 20 at a third level of access that is associated with a third amount of content access latency and a third amount of associated fee.

In some implementations, operation 748 may further include or involve an operation 749 for obtaining the at least one bid that includes at least the first request for accessing the content at the first level of access, the second request for accessing the content at the second level of access, and the third request for accessing the content at the third level of access, where the first request being a preferred request over the second and third requests, and the second request being a preferred request over the third request. For instance, the bid acquiring module 104* of the computing system 10* of FIG. 3A or 3B obtaining the at least one bid 40 that includes at least the first request for accessing the content 20 at the first level of access, the second request for accessing the content 20 at the second level of access, and the third request for accessing the content 20 at the third level of access, where the first request being a preferred request over the second and third requests, and the second request being a preferred request over the third request (e.g., the first request being the primary choice, the second request being the secondary choice, and the third request being the tertiary choice).

As further illustrated in FIG. 7B, in some cases, the bid obtaining operation 504 may include or involve an operation 750 for obtaining the one or more bids by obtaining at least one bid that includes a request for contextual data related to the content. For instance, the bid acquiring module 104* of the computing system 10* of FIG. 3A or 3B obtaining the one or more bids 40 by obtaining (e.g., acquiring) at least one bid 40 that includes a request for contextual data related to the content 20.

In some cases, operation 750 may, in turn, further include or involve an operation 751 for obtaining at least one bid that includes a request for contextual data related to the content by obtaining at least one bid that includes a request for historical background information related to the content. For instance, the bid acquiring module 104* of the computing system 10* of FIG. 3A or 3B obtaining at least one bid 40 that includes a request for contextual data related to the content 20 by obtaining at least one bid 40 that includes a request for historical background information related to the content 20.

Turning now to FIG. 7C, in some implementations, the bid obtaining operation 504 may additionally or alternatively include or involve an operation 752 for obtaining the one or more bids by obtaining at least one bid that includes a request for previous consumer information related to one or more content consumers who have previously accessed the content. For instance, the bid acquiring module 104* of the computing system 10* of FIG. 3A or 3B obtaining the one or more bids 40 by obtaining (e.g., acquiring) at least one bid 40 that includes a request for previous consumer information related to one or more content consumers 62* who have previously accessed the content 20.

As further illustrated in FIG. 7C, in some implementations, operation 752 may, in turn, further include or involve an operation 753 for obtaining the at least one bid that includes the request for the previous consumer information related to one or more content consumers who have previously accessed the content by obtaining at least one bid that includes a request for information that identifies the one or more content consumers who have previously accessed the content and/or the number of one or more content consumers who have previously accessed the content. For instance, the bid acquiring module 104* of the computing system 10* of FIG. 3A or 3B obtaining the one or more bids 40 by obtaining at least one bid 40 that includes a request for previous consumer information related to one or more content consumers 62* who have previously accessed the content 20 that includes the request for the previous consumer information related to one or more content consumers 62* who have previously accessed the content 20 by obtaining at least one bid 40 that includes a request for information that identifies the one or more content consumers 62* who have previously accessed the content 20 and/or the number of one or more content consumers 62* who have previously accessed the content 20.

In some implementations, operation 752 may alternatively or additionally include an operation 754 for obtaining the at least one bid that includes the request for the previous consumer information related to one or more content consumers who have previously accessed the content by obtaining at least one bid that includes a request for information that indicates when and/or how the one or more content consumers who have previously accessed the content actually accessed the content. For instance, the bid acquiring module 104* of the computing system 10* of FIG. 3A or 3B obtaining the at least one bid 40 that includes the request for the previous consumer information related to one or more content consumers 62* who have previously accessed the content 20 by obtaining at least one bid 40 that includes a request for information that indicates when and/or how (e.g., the bandwidth or network used to access the content 20) the one or more content consumers 62* who have previously accessed the content 20 actually accessed the content 20.

In some cases, the bid obtaining operation 504 may include an operation 755 for obtaining the one or more bids by obtaining at least one bid that includes a request for previous consumer information related to one or more content consumers who will have earlier access to the content than the access requested through the at least one bid. For instance, the bid acquiring module 104* of the computing system 10* of FIG. 3A or 3B obtaining the one or more bids 40 by obtaining at least one bid 40 that includes a request for previous consumer information related to one or more content consumers 62* who will have earlier access to the content 20 than the access requested through the at least one bid 40. Note that operation 755 is different from operation 752 because operation 752 relates to content consumers 62* who already had early access to the content 20 while operation 755 relates to content consumers 62* who will have earlier access (e.g., earlier access than the access requested through the at least one bid 40) to the content 20 in the future.

As further illustrated in FIG. 7C, in some implementations, operation 755 may further include or involve an operation 756 for obtaining the at least one bid that includes the request for the previous consumer information related to the one or more content consumers who will have earlier access to the content than the level access requested through the at least one bid by obtaining at least one bid that includes a request for information that identifies the one or more content consumers who will have earlier access to the content than the level access requested through the at least one bid and/or the number of one or more content consumers who will have earlier access to the content than the level access requested through the at least one bid. For instance, the bid acquiring module 104* of the computing system 10* of FIG. 3A or 3B obtaining the at least one bid 40 that includes the request for the previous consumer information related to the one or more content consumers 62* who will have earlier access to the content 20 than the level access requested through the at least one bid 40 by obtaining at least one bid 40 that includes a request for information that identifies the one or more content consumers 62* who will have earlier access to the content 20 than the level access requested through the at least one bid 40 and/or the number of one or more content consumers 62* who will have earlier access to the content 20 than the level access requested through the at least one bid 40.

In the same or alternative implementations, operation 755 may include an operation 757 for obtaining the at least one bid that includes the request for the previous consumer information related to the one or more content consumers who will have earlier access to the content than the level access requested through the at least one bid by obtaining at least one bid that includes a request for information that indicates when and/or how the one or more content consumers will actually access the content. For instance, the bid acquiring module 104* of the computing system 10* of FIG. 3A or 3B obtaining the at least one bid 40 that includes the request for the previous consumer information related to the one or more content consumers 62* who will have earlier access to the content 20 than the level access requested through the at least one bid 40 by obtaining at least one bid 40 that includes a request for information that indicates when and/or how the one or more content consumers 62* will actually access the content 20.

In some implementations, the bid obtaining operation 504 may additionally or alternatively include an operation 758 for obtaining the one or more bids by obtaining at least one bid that was sent by a client computing device in response, at least in part, to a user entry that was entered through a selection graphical user interface (GUI) that was remotely generated at the client computing device based, at least in part, on information provided through the at least one bidding tag that was communicated and that was designed to be used for selecting a particular level of access for accessing the content from different levels of access for accessing the content, the different levels of access for accessing the content being associated with different amounts of content access latencies and different amounts of associated fees. For instance, the bid acquiring module 104* of the computing system 10* of FIG. 3A or 3B obtaining the one or more bids 40 by obtaining at least one bid 40 that was sent by a client computing device 60* in response, at least in part, to a user entry that was entered through a selection graphical user interface (e.g., selection GUI 200a or 200b of FIG. 2A or 2B) that was remotely generated at the client computing device 60* based, at least in part, on information provided through the at least one bidding tag 30 that was communicated to the client computing device 60* and that was designed to be used for selecting a particular level of access for accessing the content 20 from different levels of access for accessing the content 20, the different levels of access for accessing the content 20 being associated with different amounts of content access latencies and different amounts of associated fees.

Referring back to the content releasing operation 506 of FIG. 5, the content releasing operation 506 similar to the bidding tag communicating operation 502 and the bid obtaining operation 504 of FIG. 5 may be executed in a number of different ways in various alternative embodiments as illustrated in FIGS. 8A, 8B, 8C, 8D, 8E, and 8F. In some implementations, for example, the content releasing operation 506 of FIG. 5 may include an operation 859 for releasing the content by releasing the content via one or more wireless and/or wired networks as illustrated in FIG. 8A. For instance, the content providing module 106* of the computing system 10* of FIG. 3A or 3B releasing the content 20 by releasing (e.g., providing) the content 20 via one or more wireless and/or wired network(s) 5.

In the same or alternative implementations, the content releasing operation 506 may additionally or alternatively include an operation 860 for releasing the content by transmitting the content in accordance with the one or more obtained bids. For instance, the content providing module 106* including the content transmitting module 416 (see FIG. 4B) of the computing system 10* of FIG. 3A or 3B releasing the content 20 when the content transmitting module 416 transmits the content 20 to, for example, one or more of the two or more client computing devices 60* that received the at least one bidding tag 30 and in accordance with the one or more obtained bids 40.

In the same or alternative implementations, the content releasing operation 506 may additionally or alternatively include an operation 861 for releasing the content by providing access to the content in accordance with the one or more obtained bids. For instance, the content providing module 106* including the content access providing module 418 (see FIG. 4B) of the computing system 10* of FIG. 3A or 3B releasing the content 20 when the content access providing module 418 provides access to the content 20 to, for example, one or more of the two or more client computing devices 60* that received the at least one bidding tag 30 and in accordance with the one or more obtained bids 40.

As further illustrated in FIG. 8A, in some cases operation 861 may further include or involve an operation 862 for providing access to the content in accordance with the one or more received bids by providing one or more links to access the content in accordance with the one or more obtained bids. For instance, the content access providing module 418 of the computing system 10* of FIG. 3A or 3B providing access to the content 20 in accordance with the one or more received bids 40 by providing to, for example, one or more of the two or more client computing devices 60* that received the at least one bidding tag 30 one or more links to access the content 20 in accordance with the one or more obtained bids 40.

Referring now to FIG. 8B, in some implementations, the content releasing operation 506 may include or involve an operation 863 for releasing the content in accordance with the one or more obtained bids by releasing the content to one or more client computing devices, the release of the content to the one or more client computing devices being in accordance with the one or more obtained bids. For instance, the content providing module 106* of the computing system 10* of FIG. 3A or 3B releasing the content 20 in accordance with the one or more obtained bids 40 by releasing (e.g., providing) the content 20 to one or more client computing devices 60*, the release of the content 20 to the one or more client computing devices 60* being in accordance with the one or more obtained bids 40 (e.g., being in accordance with the one or more requests of the one or more obtained bids 40).

As further illustrated in FIGS. 8B and 8C, in various implementations operation 863 may further include or involve one or more additional operations including, in some cases, an operation 864 for releasing the content to the one or more client computing devices by releasing the content to a plurality of client computing devices, the release of the content to the plurality of client computing devices being in accordance with a plurality of obtained bids as illustrated in FIG. 8B. For instance, the content providing module 106* of the computing system 10* of FIG. 3A or 3B releasing the content 20 to the one or more client computing devices 60* by releasing the content 20 to a plurality of client computing devices 60* (e.g., electronic trading platforms such as Bloomberg terminals, desktop computers, workstations, mobile computing devices, and so forth), the release (e.g., providing or distribution) of the content 20 to the plurality of client computing devices 60* being in accordance with a plurality of obtained bids 40.

In some implementations, operation 864 may include an operation 865 for releasing the content to the plurality of client computing devices in accordance with the plurality of obtained bids by releasing the content to a plurality of client computing devices that sent the obtained bids. For instance, the content providing module 106* of the computing system 10* of FIG. 3A or 3B releasing the content 20 to the plurality of client computing devices 60* in accordance with the plurality of obtained bids 40 by releasing the content 20 to a plurality of client computing devices 60* that sent the obtained bids 40.

In the same or alternative implementations, operation 864 may include an operation 866 for releasing the content to the plurality of client computing devices in accordance with the plurality of obtained bids by releasing the content to the plurality of client computing devices at different predetermined points in time as requested through the plurality of obtained bids. For instance, the content providing module 106* of the computing system 10* of FIG. 3A or 3B releasing the content 20 to the plurality of client computing devices 60* in accordance with the plurality of obtained bids 40 by releasing the content 20 to the plurality of client computing devices 60* at different predetermined points in time as requested through the plurality of obtained bids 40.

In some cases, operation 866 may further include or involve an operation 867 for releasing the content to the plurality of client computing devices at different predetermined points in time as requested through the plurality of obtained bids including releasing the content to a first one or more client computing devices only after a first latency following a point in time has lapsed and releasing the content to a second one or more client computing devices only after a second latency following the point in time has lapsed, the first latency and the second latency being different latencies and having been requested through the plurality of obtained bids. For instance, the content providing module 106* of the computing system 10* of FIG. 3A or 3B releasing the content 20 to the plurality of client computing devices 60* at different predetermined points in time as requested through the plurality of obtained bids 40 including releasing the content 20 to a first one or more client computing devices 60* (e.g., client computing device 60a of FIG. 1) only after a first latency (e.g., a first time delay) following a point in time (e.g., an arbitrary point in time such as the earliest point in time in which financial or market news is available or the point in time when a movie is released in theaters) has lapsed and releasing the content 20 to a second one or more client computing devices 60* (e.g., client computing device 60b of FIG. 1) only after a second latency (e.g., a second time delay) following the point in time has lapsed, the first latency and the second latency (being different latencies) and having been requested through the plurality of obtained bids 40.

In some implementations, operation 867 may further include an operation 868 for releasing the content to the first one or more client computing devices and the second one or more client computing devices by further releasing the content to a third one or more client computing devices only after a third latency following the point in time has lapsed, the first latency, the second latency, and the third latency being different latencies and having been requested through the plurality of obtained bids. For instance, the content providing module 106* of the computing system 10* of FIG. 3A or 3B releasing the content 20 to the first one or more client computing devices 60* (e.g., client computing device 60a) and the second one or more client computing devices 60* (e.g., client computing device 60b) by further releasing the content 20 to a third one or more client computing devices 60* (e.g., client computing devices 60c and 60d of FIG. 1) only after a third latency (e.g., a third time delay) following the point in time has lapsed, the first latency (e.g., first time delay), the second latency, (e.g., second time delay) and the third latency (e.g., third time delay) being different latencies and having been requested through the plurality of obtained bids 40.

In some cases, operation 866 may include or involve an operation 869 for releasing the content to the plurality of client computing devices at different predetermined points in time as requested through the plurality of bids by releasing the content to the plurality of client computing devices at three or more different predetermined points in time as requested, at least in part, through the plurality of obtained bids as illustrated in FIG. 8C. For instance, the content providing module 106* of the computing system 10* of FIG. 3A or 3B releasing the content 20 to the plurality of client computing devices 60* at different predetermined points in time as requested through the plurality of bids 40 by releasing the content 20 to the plurality of client computing devices 60* at three or more different predetermined points in time as requested, at least in part, through the plurality of obtained bids 40.

As further illustrated in FIG. 8C, in some cases, operation 869 may, in turn, further include an operation 870 for releasing the content to the plurality of client computing devices at three or more different predetermined points in time by releasing the content to the plurality of client computing devices at ten or more different predetermined points in time as requested, at least in part, through the plurality of obtained bids. For instance, the content providing module 106* of the computing system 10* of FIG. 3A or 3B releasing the content 20 to the plurality of client computing devices 60* at three or more different predetermined points in time by releasing the content 20 to the plurality of client computing devices 60* (e.g., to at least 10 client computing devices 60*) at ten or more different predetermined points in time as requested, at least in part, through the plurality of obtained bids 40.

In some cases, operation 870 may further include or involve an operation 871 for releasing the content to the plurality of client computing devices at ten or more different predetermined points in time by releasing the content to the plurality of client computing devices at thirty or more different predetermined points in time as requested, at least in part, through the plurality of obtained bids. For instance, the content providing module 106* of the computing system 10* of FIG. 3A or 3B releasing the content 20 to the plurality of client computing devices 60* at ten or more different predetermined points in time by releasing the content 20 to the plurality of client computing devices 60* (e.g., to at least 30 client computing devices 60*) at thirty or more different predetermined points in time as requested, at least in part, through the plurality of obtained bids 40.

In the same or alternative implementations, operation 864 for releasing the content to the one or more client computing devices by releasing the content to a plurality of client computing devices, the release of the content to the plurality of client computing devices being in accordance with a plurality of obtained bids may additionally or alternatively include an operation 872 for releasing the content to the plurality of client computing devices in accordance with the plurality of obtained bids by releasing the content to at least one client computing device prior to lapse of a latency following a point in time, the latency having been requested through an obtained bid, and providing to the at least one client computing device one or more instructions to provide access to the content only after the latency following the point in time has lapsed. For instance, the content providing module 106* including the content access releasing instructions providing module 420 (see FIG. 4B) of the computing system 10* of FIG. 3A or 3B releasing the content 20 to the plurality of client computing devices 60* in accordance with the plurality of obtained bids 40 by releasing the content 20 to at least one client computing device 60* prior to lapse of a latency following a point in time (e.g., an arbitrary point in time such as the earliest point in time in which financial or market information is available or when a movie is released in theaters), the latency having been requested through an obtained bid 40, and the content access releasing instructions providing module 420 providing to the at least one client computing device 60* one or more instructions to provide (e.g., release) access to the content 20 only after the latency (e.g., time delay) following the point in time has lapsed.

Referring now to FIG. 8D, in some implementations, the content releasing operation 506 of FIG. 5 may additionally or alternatively include an operation 873 for releasing the content by releasing the content to a plurality of client computing devices and releasing to at least a sub-group of the plurality of client computing devices previous consumer information related to one or more content consumers who have previously accessed the content. For instance, the content providing module 106* including the previous consumer information providing module 422 (see FIG. 4B) of the computing system 10* of FIG. 3A or 3B releasing the content 20 by releasing (e.g., providing) the content 20 to a plurality of client computing devices 60* and releasing, by the previous consumer information providing module 422, to at least a sub-group of the plurality of client computing devices 60* previous consumer information related to one or more content consumers 62* who have previously accessed the content 20 (e.g., content related to business, financial, and/or market news). For example, suppose in the example environment 100 of FIG. 1 the client computing devices 60a and 60b (along with their content consumers 62a and 62b) are given access to content 20 before client computing devices 60c and 60d (and its content consumers 62c and 62d) are given access to the content 20, then client computing devices 60c and 60d may be provided with information related to content consumers 62a and 62b (e.g., previous consumer information) who had earlier access to the content 20.

In some implementations, operation 873 may further include or involve an operation 874 for releasing to at least the sub-group of the plurality of client computing devices previous consumer information related to the one or more content consumers who have previously accessed the content by releasing to at least the sub-group of the plurality of client computing devices information that identifies the one or more content consumers who have previously accessed the content and/or the number of one or more content consumers who have previously accessed the content. For instance, the previous consumer information providing module 422 of the computing system 10* of FIG. 3A or 3B releasing to at least the sub-group (e.g., client computing devices 60c and 60d of FIG. 1) of the plurality of client computing devices 60* previous consumer information related to the one or more content consumers (e.g., content consumers 62a and 62b of FIG. 1) who have previously accessed the content 20 by releasing to at least the sub-group (e.g., client computing devices 60c and 60d) of the plurality of client computing devices 60* information that identifies the one or more content consumers 62a and 62b who have previously accessed the content 20 and/or the number of one or more content consumers 62a and 62b who have previously accessed the content 20.

In the same or alternative implementations, operation 873 may include or involve an operation 875 for releasing to at least the sub-group of the plurality of client computing devices previous consumer information related to the one or more content consumers who have previously accessed the content by releasing to at least the sub-group of the plurality of client computing devices information that indicates when and/or how the one or more content consumers who have previously accessed the content actually accessed the content. For instance, the previous consumer information providing module 422 of the computing system 10* of FIG. 3A or 3B releasing to at least the sub-group (e.g., client computing devices 60c and 60d of FIG. 1) of the plurality of client computing devices 60* previous consumer information related to the one or more content consumers (e.g., content consumers 62a and 62b of FIG. 1) who have previously accessed the content 20 by releasing to at least the sub-group (e.g., client computing devices 60c and 60d of FIG. 1) of the plurality of client computing devices 60* information that indicates when and/or how (e.g., type of networks used or bandwidth used) the one or more content consumers 62a and 62b who have previously accessed the content 20 actually accessed the content 20.

In some implementations, the content releasing operation 506 may include an operation 876 for releasing the content by releasing the content to a plurality of client computing devices and releasing to at least a sub-group of the plurality of client computing devices contextual information related to the content. For instance, the content providing module 106* including the contextual information providing module 424 (see FIG. 4B) of the computing system 10* of FIG. 3A or 3B releasing the content 20 by releasing the content 20 to a plurality of client computing devices 60* and releasing, by the contextual information providing module 424, to at least a sub-group (e.g., client computing devices 60a and 60b of FIG. 1) of the plurality of client computing devices 60* contextual information (e.g., historical financial or market data, movie trailers, etc.) related to the content 20. For example, content consumers 62* who pay a higher premium (e.g., pay for greater content access) may be given greater access to contextual information related to the content 20 than those who pay less for content access. In alternative implementations, those who pay a premium may not be provided with contextual information. For example, if the content 20 is a theatrical movie, than a higher paying customer (e.g., content consumer 60*) who is not interested in seeing movie trailers (e.g., contextual information) of other movies may not be provided with such movie trailers.

In some cases, operation 876 may actually include or involve an operation 877 for releasing the contextual information to at least the sub-group of the plurality of client computing devices by releasing the contextual information to a first sub-group of the plurality of client computing devices while not releasing the contextual information to a second sub-group of the plurality of client computing devices. For instance, the contextual information providing module 424 of the computing system 10* of FIG. 3A or 3B releasing the contextual information to at least the sub-group (e.g., client computing devices 60a and 60b of FIG. 1) of the plurality of client computing devices 60* by releasing the contextual information to a first sub-group of the plurality of client computing devices (e.g., client computing devices 60a and 60b of FIG. 1) while not releasing the contextual information to a second sub-group (e.g., client computing devices 60c and 60d of FIG. 1) of the plurality of client computing devices 60*.

In the same or alternative implementations, operation 876 may additionally or alternatively include an operation 878 for releasing the contextual information to at least the sub-group of the plurality of client computing devices by releasing to at least the sub-group of the plurality of client computing devices historical background information related to the content. For instance, the contextual information providing module 424 of the computing system 10* of FIG. 3A or 3B releasing the contextual information to at least the sub-group (e.g., client computing devices 60a and 60b of FIG. 1) of the plurality of client computing devices 60* by releasing to at least the sub-group (e.g., client computing devices 60a and 60b of FIG. 1) of the plurality of client computing devices 60* historical background information (e.g., historical financial or market information) related to the content 20 (e.g., financial or market news).

Turning now to FIG. 8E, in some implementations, the content releasing operation 506 may additionally or alternatively include an operation 879 for releasing the content by releasing news content. For instance, the content providing module 106* including the news content providing module 426 (see FIG. 4B) of the computing system 10* of FIG. 3A or 3B releasing the content 20 when the news content providing module 426 releases (e.g., provides) news content in accordance with the one or more obtained or acquired bids 40.

As further illustrated in FIG. 8E, operation 879 in various implementations may further include one or more additional operations including, in some cases, an operation 880 for releasing the news content by releasing business, financial, and/or market news content. For instance, the news content providing module 426 of the computing system 10* of FIG. 3A or 3B releasing the news content by releasing business, financial, and/or market news content.

In the same or alternative implementations, operation 879 may additionally or alternatively include an operation 881 for releasing the news content by releasing human interest news content. For instance, the news content providing module 426 of the computing system 10* of FIG. 3A or 3B releasing the news content by releasing human interest news content (e.g., news related to a particular person or persons, societal events, natural occurrences including natural weather or seismic events including natural disasters, and so forth).

In some cases, operation 881 may further include an operation 882 for releasing the human interest news content by releasing celebrity news content. For instance, the news content providing module 426 of the computing system 10* of FIG. 3A or 3B releasing the human interest news content by releasing celebrity news content (e.g., news related to a particular actress or athlete).

In the same or alternative implementations, operation 879 may additionally or alternatively include an operation 883 for releasing the news content by releasing political, governmental, and/or regulatory news content. For instance, the news content providing module 426 of the computing system 10* of FIG. 3A or 3B releasing the news content by releasing political, governmental, and/or regulatory news content.

As also further illustrated in FIG. 8E, the content releasing operation 506 of FIG. 5 may include an operation 884 for releasing the content by releasing consumable media in various implementations. For instance, the content providing module 106* including the consumable media providing module 428 (see FIG. 4B) of the computing system 10* of FIG. 3A or 3B releasing the content 20 including releasing, by the consumable media providing module 428, of consumable media in accordance with the one or more obtained or acquired bids 40.

In some cases, operation 884 may further include an operation 885 for releasing the consumable media by releasing an electronic textual document, a video, or an audio recording. For instance, the consumable media providing module 428 of the computing system 10* of FIG. 3A or 3B releasing the consumable media by releasing an electronic textual document, a video, or an audio recording.

In some cases, operation 885 may, in turn, further include an operation 886 for releasing the electronic textual document, the video, or the audio recording by releasing a movie, a recording of a sports event, or a recording of a concert. For instance, the consumable media providing module 428 of the computing system 10* of FIG. 3A or 3B releasing the electronic textual document, the video, or the audio recording by releasing a movie, a recording of a sports event, or a recording of a concert.

In some cases, operation 885 may include an operation 887 for releasing the electronic textual document, the video, or the audio recording by releasing an electronic novel, an electronic reference book, or an electronic biography. For instance, the consumable media providing module 428 of the computing system 10* of FIG. 3A or 3B releasing the electronic textual document, the video, or the audio recording by releasing an electronic novel, an electronic reference book, or an electronic biography.

Turning now to FIG. 8F, in some implementations, the content releasing operation 506 may include an operation 888 for releasing the content including releasing to one or more client computing devices data that at least facilitates generation at the one or more client computing devices of a graphical user interface (GUI) that provides an option for displaying and/or audibly presenting the content. For instance, the content providing module 106* including the content presentation option GUI data providing module 430 (see FIG. 4B) of the computing system 10* of FIG. 3A or 3B releasing the content 20 including releasing to one or more client computing devices 60*, by the content presentation option GUI data providing module 430, of data that at least facilitates generation at the one or more client computing devices 60* of a graphical user interface (see visual presentation 250k of FIG. 2K) that provides an option (e.g., icon 220k of FIG. 2K) for displaying and/or audibly presenting the content 20.

In the same or alternative implementations, the content releasing operation 506 may include an operation 889 for releasing the content including releasing to one or more client computing devices data that at least facilitates generation at the one or more client computing devices of a graphical user interface (GUI) that provides an option for displaying and/or audibly presenting contextual data related to the content. For instance, the content providing module 106* including the contextual data presentation option GUI data providing module 432 (see FIG. 4B) of the computing system 10* of FIG. 3A or 3B releasing the content 20, including releasing to one or more client computing devices 60* by the contextual data presentation option GUI data providing module 432 of data that at least facilitates generation at the one or more client computing devices of a graphical user interface (GUI) that provides an option (e.g., icon 209a of FIG. 2A, which although is depicted in FIG. 2A as being included in a selection GUI 200a may also be included in a GUI that is presented in subsequent GUIs) for displaying and/or audibly presenting contextual data (e.g., historical background information related to the content such as historical stock market prices or movie trailers for movies of similar genre) related to the content 20.

In the same or alternative implementations, the content releasing operation 506 may include an operation 890 for releasing the content including releasing to one or more client computing devices data that at least facilitates generation at the one or more client computing devices of a graphical user interface (GUI) that provides an option for displaying and/or audibly presenting previous consumer information related to one or more content consumers who have previously accessed the content. For instance, the content providing module 106* including the previous consumer information presentation option GUI data providing module 434 (see FIG. 4B) of the computing system 10* of FIG. 3A or 3B releasing the content 20, including releasing to one or more client computing devices 60* by the previous consumer information presentation option GUI data providing module 434, of data that at least facilitates generation at the one or more client computing devices 60* of a graphical user interface (GUI) that provides an option (e.g., icon 207a of FIG. 2A, which although is depicted in FIG. 2A as being included in a selection GUI 200a may also be included in a GUI that is presented in subsequent GUIs) for displaying and/or audibly presenting previous consumer information related to one or more content consumers 62* who have previously accessed the content 20.

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en.wikipedia.org/wiki/Logic_gates (as of Jun. 5, 2012, 21:03 GMT).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en.wikipedia.org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wiki/Instructions_per_second (as of Jun. 5, 2012, 21:04 GMT). Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

Those having skill in the art will recognize that the state of the art has progressed to the point where there is little distinct ion left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware in one or more machines, compositions of matter, and articles of manufacture, limited to patentable subject matter under 35 USC 101. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled/implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

This application may make reference to one or more trademarks, e.g., a word, letter, symbol, or device adopted by one manufacturer or merchant and used to identify and/or distinguish his or her product from those of others. Trademark names used herein are set forth in such language that makes clear their identity, that distinguishes them from common descriptive nouns, that have fixed and definite meanings, or, in many if not all cases, are accompanied by other specific identification using terms not covered by trademark. In addition, trademark names used herein have meanings that are well-known and defined in the literature, or do not refer to products or compounds for which knowledge of one or more trade secrets is required in order to divine their meaning. All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or bracketed capitalization (e.g., [trademark name]), even when such trademark symbol does not explicitly appear next to the trademark. To the extent a trademark is used in a descriptive manner to refer to a product or process, that trademark should be interpreted to represent the corresponding product or process as of the date of the filing of this patent application.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

1-181. (canceled)

182. A system comprising:
a bidding tag transmitting module configured to transmit to two or more client computing devices at least one bidding tag that is designed to elicit one or more bids for accessing a content that is being offered for consumption, at least in part, through the at least one bidding tag at different levels of access for accessing the content, the different levels of access for accessing the content being associated with different amounts of content access latencies and different amounts of associated fees;
a bid acquiring module configured to acquire one or more bids from one or more of the two or more client computing devices that the at least one bidding tag was transmitted to, the acquiring of the one or more bids being a result, at least in part, of transmitting the at least one bidding tag, the one or more bids to be obtained being at least one or more requests for accessing the content at one or more levels of the different levels of access for accessing the content that is being offered for consumption through the at least one bidding tag; and
a content providing module configured to provide the content in accordance with the one or more acquired bids.

183. (canceled)

184. The system of claim 182, wherein said bidding tag transmitting module configured to transmit to two or more client computing devices at least one bidding tag that is designed to elicit one or more bids for accessing a content that is being offered for consumption, at least in part, through the at least one bidding tag at different levels of access for accessing the content, the different levels of access for accessing the content being associated with different amounts of content access latencies and different amounts of associated fees comprises:
a bidding tag transmitting module configured to transmit to the two or more client computing devices at least one bidding tag that at least identifies the content being offered for consumption as being news content.

185. The system of claim 184, wherein said bidding tag transmitting module configured to transmit to the two or more client computing devices at least one bidding tag that at least identifies the content being offered for consumption as being news content comprises:
a bidding tag transmitting module configured to transmit to the two or more client computing devices at least one bidding tag that at least identifies the content being offered for consumption as being business, financial, and/or market news.

186. (canceled)

187. (canceled)

188. The system of claim 184, wherein said bidding tag transmitting module configured to transmit to the two or more client computing devices at least one bidding tag that at least identifies the content being offered for consumption as being news content comprises:
a bidding tag transmitting module configured to transmit to the two or more client computing devices at least one bidding tag that at least identifies the content being offered for consumption as being political, governmental, and/or regulatory news.

189. The system of claim 182, wherein said bidding tag transmitting module configured to transmit to two or more client computing devices at least one bidding tag that is designed to elicit one or more bids for accessing a content that is being offered for consumption, at least in part, through the at least one bidding tag at different levels of access for accessing the content, the different levels of access for accessing the content being associated with different amounts of content access latencies and different amounts of associated fees comprises:
a bidding tag transmitting module configured to transmit to the two or more client computing devices at least one bidding tag that at least identifies the content being offered for consumption is consumable media.

190. (canceled)

191. The system of claim 182, wherein said bidding tag transmitting module configured to transmit to two or more client computing devices at least one bidding tag that is designed to elicit one or more bids for accessing a content that is being offered for consumption, at least in part, through the at least one bidding tag at different levels of access for accessing the content, the different levels of access for accessing the content being associated with different amounts of content access latencies and different amounts of associated fees comprises:
a selection GUI data transmitting module configured to transmit to the two or more client computing devices data that at least facilitates visual generation of at least one selection graphical user interface (selection GUI) that is designed for selecting a particular level of access for accessing the content from the different levels of access for accessing the content.

192. (canceled)

193. The system of claim 191, wherein said selection GUI data transmitting module configured to transmit to the two or more client computing devices data that at least facilitates visual generation of at least one selection graphical user interface (selection GUI) that is designed for selecting a particular level of access for accessing the content from the different levels of access for accessing the content comprises:
a selection GUI data transmitting module configured to transmit to the two or more client computing devices data that at least facilitates visual generation of a selection GUI that includes a slider feature having an elongated element and a slider icon that is designed to be moveable, in response to user input, along length of the elongated element having a first end and a second end at opposite ends of the length of the elongated element, the slider icon being designed to be moved along the length of the elongated element from the first end to the second end to select the level of access for accessing the content.

194. The system of claim 193, wherein said selection GUI data transmitting module configured to transmit to the two or more client computing devices data that at least facilitates visual generation of a selection GUI that includes a slider feature having an elongated element and a slider icon that is designed to be moveable, in response to user input, along length of the elongated element having a first end and a second end at opposite ends of the length of the elongated element, the slider icon being designed to be moved along the length of the elongated element from the first end to the second end to select the level of access for accessing the content comprises:
a selection GUI data transmitting module configured to transmit to the two or more client computing devices data that at least facilitates visual generation of a slider feature that includes a slider icon that is designed to be moveable, in response to user input, along the length of the elongated element having a first end and a second end and having multiple points along the length of the elongated element including the first end and the second end, the multiple points along the length of the elongated element from the first end to the second end being associated with graduated levels of access for accessing the content with varying amounts of latencies for accessing the content and varying amounts of associated fees, the first end corresponding to highest level of access that is available along the elongated element for accessing the content with lowest amount of latency and highest fee that are available along the elongated element and the second end corresponding to lowest access available along the elongated element for accessing the content with highest amount of latency and lowest fee that are available along the elongated element, and each point along the elongated element from the second end to the first end corresponding to incrementally increasing levels of access for accessing the content with decreasing amounts of latencies and increasing amounts of associated fees.

195. The system of claim 193, wherein said selection GUI data transmitting module configured to transmit to the two or more client computing devices data that at least facilitates visual generation of a selection GUI that includes a slider feature having an elongated element and a slider icon that is designed to be moveable, in response to user input, along length of the elongated element having a first end and a second end at opposite ends of the length of the elongated element, the slider icon being designed to be moved along the length of the elongated element from the first end to the second end to select the level of access for accessing the content comprises:
a selection GUI data transmitting module configured to transmit to the two or more client computing devices data that at least facilitates visual generation of a slider feature having an elongated element and a slider icon that is designed to be moveable, in response to user input, along the length of the elongated element having at least a first end and a second end and having at least three points along the length of the elongated element including the first end, the second end, and at least a third point between the first end and the second end, each of the at least three points along the length of the elongated element from the first end to the second end being associated with a different level of access for accessing the content with a different amount of latency for accessing the content and different amount of associated fee.

196. The system of claim 195, wherein said selection GUI data transmitting module configured to transmit to the two or more client computing devices data that at least facilitates visual generation of a slider feature having an elongated element and a slider icon that is designed to be moveable, in response to user input, along the length of the elongated element having at least a first end and a second end and having at least three points along the length of the elongated element including the first end, the second end, and at least a third point between the first end and the second end, each of the at least three points along the length of the elongated element from the first end to the second end being associated with a different level of access for accessing the content with a different amount of latency for accessing the content and different amount of associated fee comprises:
a selection GUI data transmitting module configured to transmit to the two or more client computing devices data that at least facilitates visual generation of a slider feature having an elongated element and a slider icon that is designed to be moveable, in response to user input, along the length of the elongated element having at least 10 points along the length of the elongated element including a first end and a second end, each of the at least 10 points along the length of the elongated element from the first end to the second end being associated with a different level of access for accessing the content with a different amount of latency for accessing the content and different amount of associated fee.

197. (canceled)

198. The system of claim 191, wherein said selection GUI data transmitting module configured to transmit to the two or more client computing devices data that at least facilitates visual generation of at least one selection graphical user interface (selection GUI) that is designed for selecting a particular level of access for accessing the content from the different levels of access for accessing the content comprises:
a selection GUI data transmitting module configured to transmit to the two or more client computing devices data that at least facilitates visual generation of a plurality of icons that are designed to be used for selecting a specific level of access for accessing the content from the different levels of access for accessing the content, each of the plurality of icons to be generated being associated with a different level of access for accessing the content with a different amount of latency for accessing the content and different amount of associated fee.

199. The system of claim 198, wherein said selection GUI data transmitting module configured to transmit to the two or more client computing devices data that at least facilitates visual generation of a plurality of icons that are designed to be used for selecting a specific level of access for accessing the content from the different levels of access for accessing the content, each of the plurality of icons to be generated being associated with a different level of access for accessing the content with a different amount of latency for accessing the content and different amount of associated fee comprises:
a selection GUI data transmitting module configured to transmit to the two or more client computing devices data that at least facilitates visual generation of a plurality of button icons that are designed to be used for selecting the specific level of access for accessing the content from the different levels of access for accessing the content.

200. (canceled)

201. (canceled)

202. The system of claim 191, wherein said selection GUI data transmitting module configured to transmit to the two or more client computing devices data that at least facilitates visual generation of at least one selection graphical user interface (selection GUI) that is designed for selecting a particular level of access for accessing the content from the different levels of access for accessing the content comprises:
a selection GUI data transmitting module configured to transmit to the two or more client computing devices data that at least facilitates visual generation of at least one selection GUI that includes an option for obtaining and/or presenting contextual information related to the content.

203. The system of claim 202, wherein said selection GUI data transmitting module configured to transmit to the two or more client computing devices data that at least facilitates visual generation of at least one selection GUI that includes an option for obtaining and/or presenting contextual information related to the content comprises:
a selection GUI data transmitting module configured to transmit to the two or more client computing devices data that at least facilitates visual generation of at least one selection GUI that includes an option for obtaining and/or presenting historical background information related to the content.

204. The system of claim 191, wherein said selection GUI data transmitting module configured to transmit to the two or more client computing devices data that at least facilitates visual generation of at least one selection graphical user interface (selection GUI) that is designed for selecting a particular level of access for accessing the content from the different levels of access for accessing the content comprises:
a selection GUI data transmitting module configured to transmit to the two or more client computing devices data that at least facilitates visual generation of at least one selection GUI that includes an option for obtaining and/or presenting previous consumer information related to one or more content consumers who have previously accessed the content.

205. The system of claim 204, wherein said selection GUI data transmitting module configured to transmit to the two or more client computing devices data that at least facilitates visual generation of at least one selection GUI that includes an option for obtaining and/or presenting previous consumer information related to one or more content consumers who have previously accessed the content comprises:
a selection GUI data transmitting module configured to transmit to the two or more client computing devices data that at least facilitates visual generation of at least one selection GUI that includes an option for obtaining and/or presenting information that identifies the one or more content consumers who have previously accessed the content and/or the number of one or more content consumers who have previously accessed the content.

206. The system of claim 204, wherein said selection GUI data transmitting module configured to transmit to the two or more client computing devices data that at least facilitates visual generation of at least one selection GUI that includes an option for obtaining and/or presenting previous consumer information related to one or more content consumers who have previously accessed the content comprises:
a selection GUI data transmitting module configured to transmit to the two or more client computing devices data that at least facilitates visual generation of at least one selection GUI that includes an option for obtaining and/or presenting information that indicates when and/or how the one or more content consumers who have previously accessed the content actually accessed the content.

207. The system of claim 182, wherein said bidding tag transmitting module configured to transmit to two or more client computing devices at least one bidding tag that is designed to elicit one or more bids for accessing a content that is being offered for consumption, at least in part, through the at least one bidding tag at different levels of access for accessing the content, the different levels of access for accessing the content being associated with different amounts of content access latencies and different amounts of associated fees comprises:
an access level identifying data transmitting module configured to transmit to the two or more client computing devices data that identifies the different levels of access for accessing the content including identifying for each level of access for accessing the content a corresponding content access latency and associated fee pair.

208. The system of claim 207, wherein said access level identifying data transmitting module configured to transmit to the two or more client computing devices data that identifies the different levels of access for accessing the content including identifying for each level of access for accessing the content a corresponding content access latency and associated fee pair comprises:
an access level identifying data transmitting module configured to transmit to the two or more client computing devices data that identifies for at least three different levels of access for accessing the content at least three corresponding content access latency and associated fee pairs.

209. (canceled)

210. The system of claim 182, wherein said bidding tag transmitting module configured to transmit to two or more client computing devices at least one bidding tag that is designed to elicit one or more bids for accessing a content that is being offered for consumption, at least in part, through the at least one bidding tag at different levels of access for accessing the content, the different levels of access for accessing the content being associated with different amounts of content access latencies and different amounts of associated fees comprises:
a formula data transmitting module configured to transmit to the two or more client computing devices data that provides one or more formulas designed to provide for each level of access for accessing the content, a corresponding content access latency and associated fee pair.

211. The system of claim 182, wherein said bidding tag transmitting module configured to transmit to two or more client computing devices at least one bidding tag that is designed to elicit one or more bids for accessing a content that is being offered for consumption, at least in part, through the at least one bidding tag at different levels of access for accessing the content, the different levels of access for accessing the content being associated with different amounts of content access latencies and different amounts of associated fees comprises:
a latency data and fee formula data transmitting module configured to transmit to the two or more client computing devices data that identifies different corresponding content access latencies for each of the different levels of access for accessing the content and data that identifies one or more formulas that when applied to each of the identified corresponding content access latencies provides an associated fee.

212. The system of claim 182, wherein said bidding tag transmitting module configured to transmit to two or more client computing devices at least one bidding tag that is designed to elicit one or more bids for accessing a content that is being offered for consumption, at least in part, through the at least one bidding tag at different levels of access for accessing the content, the different levels of access for accessing the content being associated with different amounts of content access latencies and different amounts of associated fees comprises:
a fee data and latency formula data transmitting module configured to transmit to the two or more client computing devices data that identifies associated fees for each of the different levels of access for accessing the content and data that identifies a formula that when applied to each of the identified associated fees provides a corresponding content access latency.

213. (canceled)

214. (canceled)

215. The system of claim 182, wherein said bidding tag transmitting module configured to transmit to two or more client computing devices at least one bidding tag that is designed to elicit one or more bids for accessing a content that is being offered for consumption, at least in part, through the at least one bidding tag at different levels of access for accessing the content, the different levels of access for accessing the content being associated with different amounts of content access latencies and different amounts of associated fees comprises:
a previous consumer information transmitting module configured to transmit to the two or more client computing devices previous consumer information related to one or more content consumers who have previously accessed the content.

216. The system of claim 215, wherein said previous consumer information transmitting module configured to transmit to the two or more client computing devices previous consumer information related to one or more content consumers who have previously accessed the content comprises:
a previous consumer information transmitting module configured to transmit to the two or more client computing devices information that identifies the one or more content consumers who have previously accessed the content and/or the number of one or more content consumers who have previously accessed the content.

217. (canceled)

218. (canceled)

219. (canceled)

220. (canceled)

221. The system of claim 182, wherein said bid acquiring module configured to acquire one or more bids from one or more of the two or more client computing devices that the at least one bidding tag was transmitted to, the acquiring of the one or more bids being a result, at least in part, of transmitting the at least one bidding tag, the one or more bids to be obtained being at least one or more requests for accessing the content at one or more levels of the different levels of access for accessing the content that is being offered for consumption through the at least one bidding tag comprises:
a bid acquiring module configured to acquire two more bids including at least a first bid that includes at least a request for accessing the content at a first level of access that is associated with a first amount of content access latency and a first amount of associated fee and a second bid that includes at least a request for accessing the content at a second level of access that is associated with a second amount of content access latency and a second amount of associated fee.

222. The system of claim 221, wherein said bid acquiring module configured to acquire two more bids including at least a first bid that includes at least a request for accessing the content at a first level of access that is associated with a first amount of content access latency and a first amount of associated fee and a second bid that includes at least a request for accessing the content at a second level of access that is associated with a second amount of content access latency and a second amount of associated fee comprises:
a bid acquiring module configured to acquire a first bid that is at least a request for accessing the content at a first level of access that is associated with a first amount of content access latency and a first amount of associated fee and a second bid that is at least a request for accessing the content at a second level of access that is associated with a second amount of content access latency and a second amount of associated fee, where the first level of access and the second level of access being different.

223. (canceled)

224. (canceled)

225. (canceled)

226. The system of claim 182, wherein said bid acquiring module configured to acquire one or more bids from one or more of the two or more client computing devices that the at least one bidding tag was transmitted to, the acquiring of the one or more bids being a result, at least in part, of transmitting the at least one bidding tag, the one or more bids to be obtained being at least one or more requests for accessing the content at one or more levels of the different levels of access for accessing the content that is being offered for consumption through the at least one bidding tag comprises:
a bid acquiring module configured to acquire at least one bid that includes at least a first request for accessing the content at a first level of access that is associated with a first amount of content access latency and a first amount of associated fee and a second request for accessing the content at a second level of access that is associated with a second amount of content access latency and a second amount of associated fee.

227. (canceled)

228. (canceled)

229. (canceled)

230. (canceled)

231. (canceled)

232. (canceled)

233. (canceled)

234. (canceled)

235. (canceled)

236. (canceled)

237. (canceled)

238. (canceled)

239. (canceled)

240. (canceled)

241. (canceled)

242. (canceled)

243. The system of claim 182, wherein said content providing module configured to provide the content in accordance with the one or more acquired bids comprises:
a content providing module configured to provide the content to one or more client computing devices, the release of the content to the one or more client computing devices being in accordance with the one or more obtained bids.

244. The system of claim 243, wherein said content providing module configured to provide the content to one or more client computing devices, the release of the content to the one or more client computing devices being in accordance with the one or more obtained bids comprises:
a content providing module configured to provide the content to a plurality of client computing devices, the release of the content to the plurality of client computing devices being in accordance with a plurality of obtained bids.

245. (canceled)

246. The system of claim 244, wherein said content providing module configured to provide the content to a plurality of client computing devices, the release of the content to the plurality of client computing devices being in accordance with a plurality of obtained bids comprises:
a content providing module configured to provide the content to the plurality of client computing devices at different predetermined points in time as requested through the plurality of obtained bids.

247. The system of claim 246, wherein said content providing module configured to provide the content to the plurality of client computing devices at different predetermined points in time as requested through the plurality of obtained bids comprises:
a content providing module configured to provide the content to a first one or more client computing devices only after a first latency following a point in time has lapsed and releasing the content to a second one or more client computing devices only after a second latency following the point in time has lapsed, the first latency and the second latency being different latencies and having been requested through the plurality of obtained bids.

248. The system of claim 247, wherein said content providing module configured to provide the content to a first one or more client computing devices only after a first latency following a point in time has lapsed and releasing the content to a second one or more client computing devices only after a second latency following the point in time has lapsed, the first latency and the second latency being different latencies and having been requested through the plurality of obtained bids comprises:
a content providing module configured to further provide the content to a third one or more client computing devices only after a third latency following the point in time has lapsed, the first latency, the second latency, and the third latency being different latencies and having been requested through the plurality of obtained bids.

249. The system of claim 246, wherein said content providing module configured to provide the content to the plurality of client computing devices at different predetermined points in time as requested through the plurality of obtained bids comprises:
a content providing module configured to provide the content to the plurality of client computing devices at three or more different predetermined points in time as requested, at least in part, through the plurality of obtained bids.

250. (canceled)

251. (canceled)

252. The system of claim 244, wherein said content providing module configured to provide the content to a plurality of client computing devices, the release of the content to the plurality of client computing devices being in accordance with a plurality of obtained bids comprises:
a content providing module including a content access releasing instructions providing module configured to provide the content to at least one client computing device prior to lapse of a latency following a point in time, the latency having been requested through an obtained bid, and the content access releasing instructions providing module configured to provide to the at least one client computing device one or more instructions to release access to the content only after the latency following the point in time has lapsed.

253. The system of claim 182, wherein said content providing module configured to provide the content in accordance with the one or more acquired bids comprises:
a content providing module including a previous consumer information providing module configured to provide the content to a plurality of client computing devices and the previous consumer information providing module configured to provide to at least a sub-group of the plurality of client computing devices previous consumer information related to one or more content consumers who have previously accessed the content.

254. (canceled)

255. (canceled)

256. (canceled)

257. (canceled)

258. (canceled)

259. The system of claim 182, wherein said content providing module configured to provide the content in accordance with the one or more acquired bids comprises:
a news content providing module configured to provide news content in accordance with the one or more acquired bids.

260. (canceled)

261. (canceled)

262. (canceled)

263. (canceled)

264. The system of claim 182, wherein said content providing module configured to provide the content in accordance with the one or more acquired bids comprises:
a consumable media providing module configured to provide consumable media in accordance with the one or more acquired bids.

265. (canceled)

266. (canceled)

267. (canceled)

268. (canceled)

269. (canceled)

270. (canceled)

271. An article of manufacture, comprising:
a non-transitory storage medium bearing:
one or more instructions for transmitting to two or more client computing devices at least one bidding tag that is designed to elicit one or more bids for accessing a content that is being offered for consumption, at least in part, through the at least one bidding tag at different levels of access for accessing the content, the different levels of access for accessing the content being associated with different amounts of content access latencies and different amounts of associated fees;
one or more instructions for acquiring one or more bids from one or more of the two or more client computing devices that the at least one bidding tag was transmitted to, the acquiring of the one or more bids being as a result, at least in part, of transmitting the at least one bidding tag, the one or more bids to be obtained being at least one or more requests for accessing the content at one or more levels of the different levels of access for accessing the content that is being offered for consumption through the at least one bidding tag; and
one or more instructions for providing the content in accordance with the one or more acquired bids.

272. A server system, comprising:
a bidding tag transmitting module configured to transmit to two or more client computing devices at least one bidding tag that is designed to elicit one or more bids for accessing a content that is being offered for consumption, at least in part, through the at least one bidding tag at different levels of access for accessing the content, the different levels of access for accessing the content being associated with different amounts of content access latencies and different amounts of associated fees;
a bid acquiring module configured to acquire one or more bids from one or more of the two or more client computing devices that the at least one bidding tag was transmitted to, the acquiring of the one or more bids being a result, at least in part, of transmitting the at least one bidding tag, the one or more bids to be obtained being at least one or more requests for accessing the content at one or more levels of the different levels of access for accessing the content that is being offered for consumption through the at least one bidding tag;
a content providing module configured to provide the content in accordance with the one or more acquired bids; and
a network interface.
